(19) United States
(12) Patent Application Publication
(10) Pub. No.: US 2001/0034244 A1
(43) Pub. Date: Oct. 25, 2001

(54) Contact management system having wireless telephone interface capability

(76) Inventors: Colin V. Calder, Inkpen (GB); Kevin E. Hodgson, Thatcham (GB)

Correspondence Address: TROUTMAN SANDERS LLP, BANK OF AMERICA PLAZA, SUITE 5200, 600 PEACHTREE STREET , NE, ATLANTA, GA, 30308-2216, US

(21) Appl. No.: 09/784,772

(22) Filed: Feb. 15, 2001

Related U.S. Application Data
(63) Continuation of application No. 09/107,931, filed on Jun. 30, 1998, now abandoned.

(51) Int. Cl. H04M 1/00

(52) U.S. Cl. 455/556; 455/550

(57) ABSTRACT

A contact management system having wireless telephone interface capability for managing contact information and the contents of a wireless telephone's phone book memory. The contact management system comprises, according to a preferred embodiment, a computer system communicatively connectable to wireless telephone, and a contact management software application operating on the computer system. The contact management system enables the collection and maintenance of information pertaining to a plurality of contacts, including voice telephone numbers of the contacts. The contact management system also enables selection and grouping of user-identified voice telephone numbers into fone lists which are independently selectable and downloadable to a wireless telephone via a communication interface which is capable of choosing an appropriate device driver which is compatible with the wireless telephone. During the creation of the fone lists, the contact management system generates abbreviated forms of contact names (i.e., short names) associated with voice telephone numbers included in the fone lists. In doing so, the system utilizes the memory limitations of the wireless telephone (i.e., as uploaded from the wireless telephone) to determine the maximum number of characters includeable in the short names. The system also utilizes the memory limitations to determine the maximum number of characters includeable in the telephone numbers and the maximum number of entries includeable in a fone list. Additionally, the system detects differences between current versions of voice telephone numbers maintained by the system and versions of voice telephone numbers previously downloaded to a wireless telephone by the system and alerts the user of the differences.

### CROSS-REFERENCE TO RELATED APPLICATION

This application is a continuation of application Ser. No. 09/107,931, filed Jun. 30, 1998, now pending.

### FIELD OF THE INVENTION

This invention relates generally to the fields of contact management systems and wireless telephones, and, in its preferred embodiment, to contact management systems which communicate data with wireless telephones.

### BACKGROUND OF THE INVENTION

In today's hectic and fast-paced world, communication with other individuals from any place and at any time has become vital to our professional and private lives. Because wireless telephones enable communication without regard to place and time, the use of wireless telephones has become widespread and will continue to grow in prevalence. With an increasing number of wireless telephones being used every day, manufacturers of wireless telephones are continually improving and upgrading the capabilities of their phones to provide them with more functionality than the wireless telephones of their competitors and of yesterday. For instance, not too long ago, wireless telephones utilizing analog communication technology were the state of the art. Then, manufacturers realized the advantages of digital communication technology and began making digital wireless telephones in lieu of the older, analog wireless telephones. Now, manufacturers have realized that many wireless telephone users often do not have a personal phone book with them at all of the locations where they use their wireless telephones. Therefore, many manufacturers have provided their wireless telephones with memories that store the names and telephone numbers of individuals with whom a wireless telephone user may wish to communicate. By scrolling through the names and telephone numbers on a display, the user can find the telephone number of an individual and, typically, by pressing a button, instruct the wireless telephone to dial the number.

While the manufacturers have seemingly resolved the user's plight with regard to not having a personal phone book with them at all times, users have come to learn that wireless telephones with memories create other difficulties. For instance, users must now periodically maintain the memories of their wireless telephones, in addition to all of their other tasks, to insure that their phone's memories contain up-to-date telephone numbers. Unfortunately, the inputting and deletion of telephone numbers via the keypad of a wireless telephone can be a chore. Also, because the memory of many wireless telephones is limited, users must grapple with deciding which telephone numbers to store and how to fit the names of individuals associated with the telephone numbers into their phone's memory. For these and other reasons, manufacturers who have often tauted wireless telephones as making life easier for their owners, have now made their owner's lives more difficult.

Therefore, there is a need in the industry for a system which enables users of wireless telephones to easily manage and maintain the phone book memories of their wireless telephones which addresses these and other related, and unrelated problems.

### SUMMARY OF THE INVENTION

Briefly described, the present invention comprises a contact management system having wireless telephone interface capability, including apparatus and methods for managing information pertaining to a plurality of contacts and for rendering the maintenance of wireless telephones less burdensome. More specifically, the present invention comprises a computer software application which enables the collection, storage, and management of contact information, including voice telephone numbers, and which interfaces to a plurality of different types of wireless telephones to enable the management of the contents of their phone book memories.

In accordance with a preferred embodiment of the present invention, the contact management system comprises a computer software application, executable by a stationary or portable computer, which communicates with a wireless telephone and which enables the management of contact information, including the voice telephone numbers of those contacts that may be potentially dialed by a user of the wireless telephone. The system enables the creation and maintenance of a plurality of lists of voice telephone numbers (referred to herein as “fone lists”) for associated contacts, with whom the user of the system may desire to converse, which are individually selectable and downloadable to the phone book memory of a wireless telephone. The system also enables the user to independently select the specific voice telephone numbers which are to be included in a particular fone list and those that are to be downloaded to a wireless telephone. Each fone list may include one, more than one, or no voice telephone numbers which are present in other fone lists. During the creation of each fone list, the system also generates an abbreviation of each contact's name in a sensible, intelligible form (referred to herein as a “short form”) that fits within the storage limitations for names in the wireless telephone's internal phone book memory (i.e., according to the memory capabilities uploaded to the system from the wireless telephone which is to be employed with the fone list). The short forms enable the ready identification of a contact when the user of the wireless telephone reviews the entries in the telephone's phone book memory while attempting to select the contact for dialing. The system also enables a user of the system to modify the short name, as desired, to adhere to personal preferences. Because the system controls the creation and revision of the fone lists, the system limits the number of entries includeable in each fone list to the maximum number of entries storable by the phone book memory of the phone in which a particular fone list will be used, thereby insuring that the entire fone list, when downloaded to a wireless telephone, will fit within the phone's phone book memory.

By enabling the creation, maintenance, and downloading of a plurality of fone lists, the system enables a user to customize a wireless telephone for use anywhere in the world. For instance, if the user travels frequently, the user may have a first fone list that includes the short names and voice telephone numbers of contacts that the user may desire to call while in a first country. The user may also have a second fone list that includes the short names and voice telephone numbers of contacts that the user may desire to call while in a second country. Because the system automatically creates and maintains contact data and fone lists having “normalized” voice telephone numbers (i.e., voice telephone numbers which include an appropriate international dialing prefix, in addition to the area code and telephone number), the user can travel without having to remember the appropriate dialing prefixes to use when making calls via the wireless telephone while outside of the user's local dialing territory or zone.

As part of the system's contact management capabilities, the system allows a user to revise contact information, including contact addresses and voice telephone numbers, as necessary. Such revisions can result in more recent version of a voice telephone number being present in the system and an earlier version of the voice telephone number being present in a wireless telephone to which the earlier version was previously downloaded. The system detects such discrepancies, modifies all of the fone lists within the system to reflect the more recent version of the voice telephone number, and alerts the user of the system to the fact that the voice telephone number stored in his wireless telephone is no longer synchronized with the voice telephone number as currently present in the system. By alerting the user, the system assists the user in avoiding situations where the user attempts to make a call using his wireless telephone and does not have the correct voice telephone number in the phone's memory because the user has forgotten that the versions of the voice telephone number in the contact management system and in his wireless telephone are different.

Various other features and advantages of the present invention will become apparent upon reading and understanding the present specification when taken in conjunction with the appended drawings.

### BRIEF DESCRIPTION OF THE DRAWINGS

FIG. 1 displays a block diagram representation of a contact management system in accordance with a preferred embodiment of the present invention.

FIG. 2 displays a logic block diagram representation of a program and data domain of the contact management system of FIG. 1.

FIG. 3 displays a logic block diagram representation of a database system of the program and data domain of FIG. 2.

FIG. 4 displays a pictorial representation of a phone configuration of the program and data domain of FIG. 2.

FIG. 5 displays a pictorial representation of an application window of the user interface of FIG. 2 having a contacts tab control in the foreground.

FIG. 6 displays a pictorial representation of an application window of the user interface of FIG. 2 having a fone lists tab control in the foreground.

FIG. 7 displays a pictorial representation of a new contact dialog box of the user interface of FIG. 2.

FIG. 8 displays a pictorial representation of a select handset type dialog box of the user interface of FIG. 2.

FIG. 9 displays a pictorial representation of a handset connection request dialog box of the user interface of FIG. 2.

FIG. 10 displays a pictorial representation of a handset name request dialog box of the user interface of FIG. 2.

FIG. 11 displays a pictorial representation of a new fone list dialog box of the user interface of FIG. 2.

FIG. 12 displays a flowchart representation of a main process of the contact management system of FIG. 1.

FIGS. 13A-E display a flowchart representation of a user interface process of the contact management system of FIG. 1.

FIG. 14 displays a flowchart representation of a populate contacts name control procedure of the contact management system of FIG. 1.

FIG. 15 displays a flowchart representation of a populate voice telephone numbers control procedure of the contact management system of FIG. 1.

FIGS. 16A-B display a flowchart representation of a populate fone list details control procedure of the contact management system of FIG. 1.

FIG. 17 displays a flowchart representation of a new contact procedure of the contact management system of FIG. 1.

FIG. 18 displays a flowchart representation of a edit contact procedure of the contact management system of FIG. 1.

FIGS. 19A-B display a flowchart representation of a new handset configuration procedure of the contact management system of FIG. 1.

FIG. 20 displays a flowchart representation of a new fone list procedure of the contact management system of FIG. 1.

FIG. 21 displays a flowchart representation of a toggle download status indicator procedure of the contact management system of FIG. 1.

FIG. 22 displays a flowchart representation of a tag all procedure of the contact management system of FIG. 1.

FIG. 23 displays a flowchart representation of a untag all procedure of the contact management system of FIG. 1.

FIGS. 24A-C display a flowchart representation of a download procedure of the contact management system of FIG. 1.

FIG. 25 displays a flowchart representation of a select handset procedure of the contact management system of FIG. 1.

FIG. 26 displays a flowchart representation of a select fone list procedure of the contact management system of FIG. 1.

FIGS. 27A-B display a flowchart representation of an add fone list entry procedure of the contact management system of FIG. 1.

FIG. 28 displays a flowchart representation of an edit short name procedure of the contact management system of FIG. 1.

FIG. 29 displays a flowchart representation of an edit telephone number procedure of the contact management system of FIG. 1.

### DETAILED DESCRIPTION OF THE PREFERRED EMBODIMENT

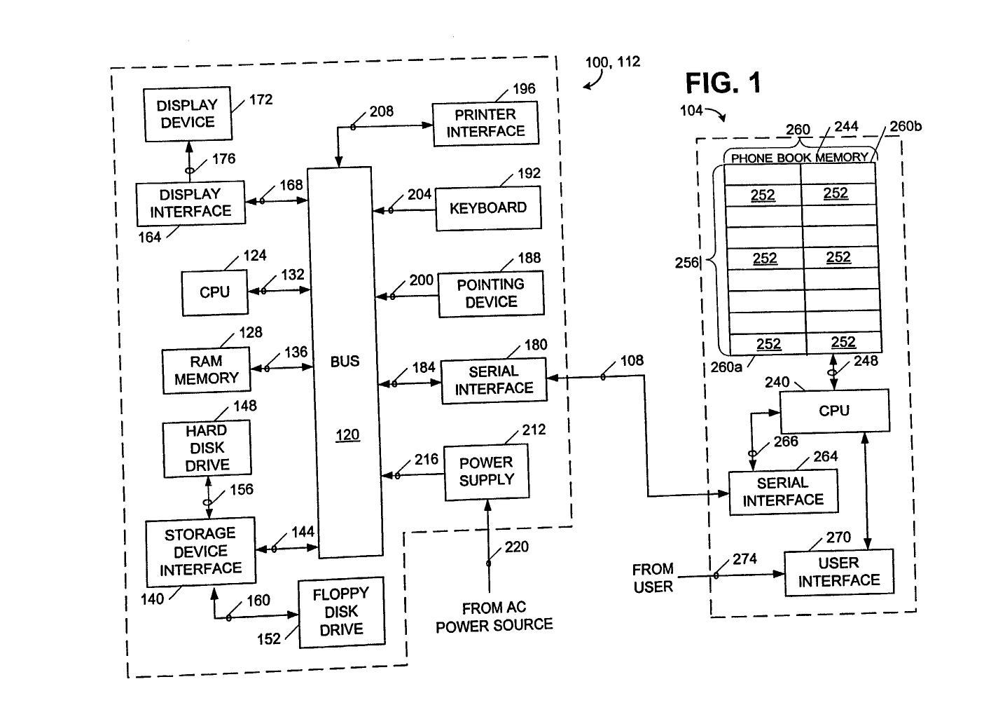

Referring now to the drawings, in which like numerals represent like components throughout the several views, FIG. 1 displays a block diagram representation of a contact management system for wireless telephones 100 (also referred to herein as the “contact management system” 100), in accordance with a preferred embodiment of the present invention, which connects to a wireless telephone 104 (also referred to herein as a “wireless handset” or as a “handset”) through data link 108. The contact management system 100 comprises a computer system 112 and a contact management application 116 (also referred to herein as the “application” and which includes software and data elements described below) residing therein which controls operation of the computer system 112 to provide management of contact information for a plurality of contacts and, more specifically, to provide management of contact telephone numbers for and between a plurality of wireless telephones 104.

The computer system 112, as seen in FIG. 1, includes a bus 120 which connects S communicatively to a central processing unit (CPU) 124 and to random access memory (RAM) 128 through respective communication paths 132, 136. The central processing unit 124 executes instructions of the software of the contact management application 116 according to a method described herein, and random access memory 128 temporarily stores portions of the application's software and data used or generated by the application's software during operation of the system 100. A central processing unit 124, acceptable according to the preferred embodiment, is an Intel-compatible 486 processor. Note that other processors having more speed and capability are also acceptable according to the preferred embodiment. Computer system 112 also comprises a storage device interface 140 which connects communicatively to the bus 120 via communication paths 144 and connects communicatively to a plurality of data storage devices 148, 152 through respective communication paths 156, 160. Preferably, data storage devices 148, 152 include a hard disk drive 148 and a floppy disk drive 152. It is understood that the scope of the present invention encompasses other types of data storage devices 148, 152. The computer system 112 additionally includes a display interface 164 which communicatively connects, via communication paths 168, to bus 120 and to a display device 172, via communication paths 176, in order to enable the presentation of visual information to a user of the system 100 as described below.

In addition, computer system 112 comprises a serial interface 180 which connects communicatively to bus 120 through communication paths 184. The serial interface 180 includes signal processing circuitry and a serial port to enable, in conjunction with the central processing unit 124, bus 120, and communication paths 132, 184, the communication of data between the central processing unit 124 and an external device such as the wireless handset 104. Computer system 112 further includes a pointing device 188, a keyboard 192, and a printer interface 196 which communicatively connect to bus 120 via respective communication paths 200, 204, 208. The pointing device 188 and keyboard 192 enable user interaction with the system 100 by allowing the user to provide the system 100 with input selections or input textual information. The computer system 112 also includes a power supply 212 which connects electrically to bus 120, via signal paths 216, and to an external alternating current power source, via signal paths 220. The power supply 212 receives alternating current electrical energy from the external alternating current power source via signal paths 220, and converts and conditions the alternating current electrical energy to produce direct current energy at appropriate voltage levels which it supplies to bus 120, through signal paths 216, for distribution to and use by the various electrical components of the computer system 112.

According to the preferred embodiment, the wireless handset 104 comprises, in addition to a plurality of communication components which perform telephonic functions and which enable wireless telephonic communication, a central processing unit (CPU) 240 and a phone book memory 244 which connect for the communication of data therebetween through communication paths 248. The phone book memory 244 stores a plurality of telephone numbers and a plurality of contact names associated therewith. The phone book memory 244 includes a plurality of memory cells 252 arranged in a two-dimensional matrix having a plurality of rows 256 and a plurality of columns 260 for each row 256. Each row 256 (also referred to herein as “row location”) of the plurality of rows 256 stores data associated with a single entry of the phone book memory 244 and includes a contact name in a first column 260a and a voice telephone number associated with that contact in a second column 260b.

The wireless handset 104, as seen in FIG. 1, also includes a serial interface 264 which connects communicatively to the handset's central processing unit 240 through communication paths 266 and to the computer system's serial interface 180 via data link 108. An exemplary data link 108, acceptable in accordance with the preferred embodiment, is a serial data cable adapted for use with the wireless handset 104. The handset's serial interface 264, acting in concert with the computer system's serial data interface 180 and connected components, enables the communication of instructions (and data appropriate for and accompanying the instructions) from the computer system's central processing unit 124 to the handset's central processing unit 240. In response to the receipt of an appropriate instruction (also referred to herein as a “command”), the handset's central processing unit 240 performs a respective action which, typically, include operations such as: (i) the reading of an entry from a designated row of the phone book memory 244 and communication of the entry to an externally connected device (i.e., computer system 112) via the handset's serial interface 264; (ii) the writing of an entry to a designated row of the phone book memory 244, the entry having been communicated to and received by the wireless handset 104 from an externally connected device (i.e., computer system 112) via serial interface 264; (iii) the communication of the attributes of the phone book memory 244 (also referred to herein as a handset's “memory attributes”), including data such as, the types of memory present in the phone book memory 244, the capacity of each type of memory in terms of the number of entries storable therein (i.e., the maximum number of row locations), the maximum size of the name portion of each entry in terms of the number of characters includeable in the name, and the maximum size of the telephone number portion of each entry in terms of the number of characters includeable in the telephone number; and, possibly, (iv) the deletion of an entry from a designated row of the phone book memory 244. A protocol set forth and developed by the wireless handset's manufacturer (and/or by industry standards bodies) determines the available instructions, the appropriate data associated therewith, if any, and the correct syntax and sequence of the instructions for a particular wireless handset 104.

The wireless handset 104 further comprises a user interface 270 which communicatively connects to the handset's central processing unit 240 through communication paths 274. Typically, the user interface 270 includes a keypad and a display which enable interaction with a user of the handset 104. Through use of the keypad, the user inputs entries, including names and telephone numbers, for storage in the phone book memory 244. Through use of the display, the user verifies correctness of the input entries and selects an entry for dialing by the communication components of the wireless handset 104.

It is understood that the scope of the present invention encompasses computer systems 112 (including both stationary and portable computer systems, both alternating current and battery powered) and wireless handsets 104 both having the elements and functionality described above. However, it is understood that the scope of the present invention further encompasses computer systems 112 and wireless handsets 104 having other types of interfaces which enable communication of commands and data therebetween. For example and not limitation, in an alternate embodiment of the present invention, a computer system 112 includes a PCMCIA Type II port which receives a PCS data card that connects via an appropriate communication cable to a compatible port of a wireless handset 104.

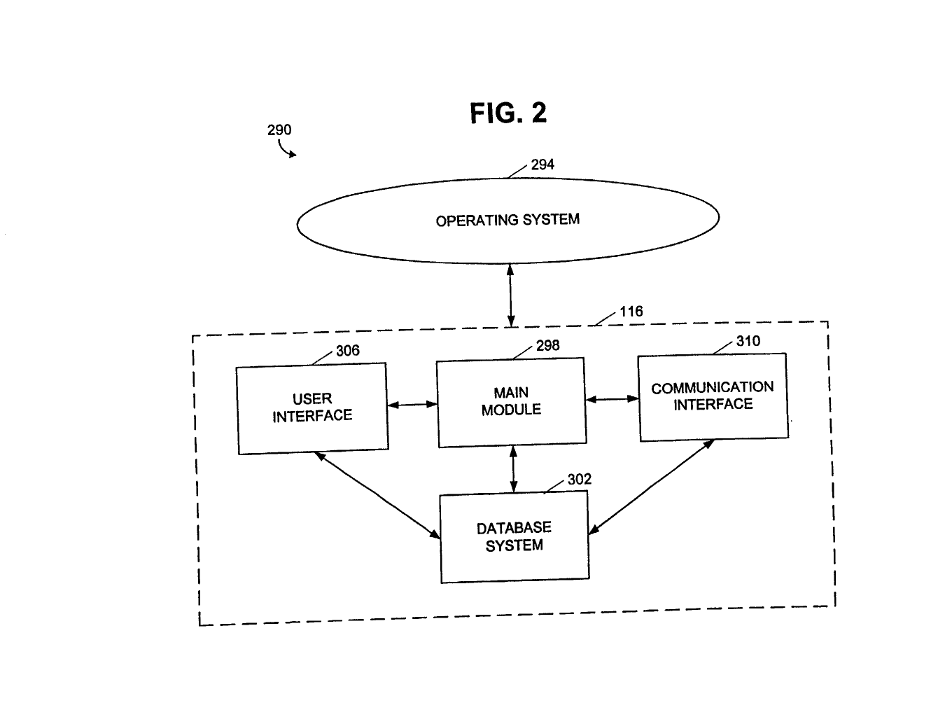

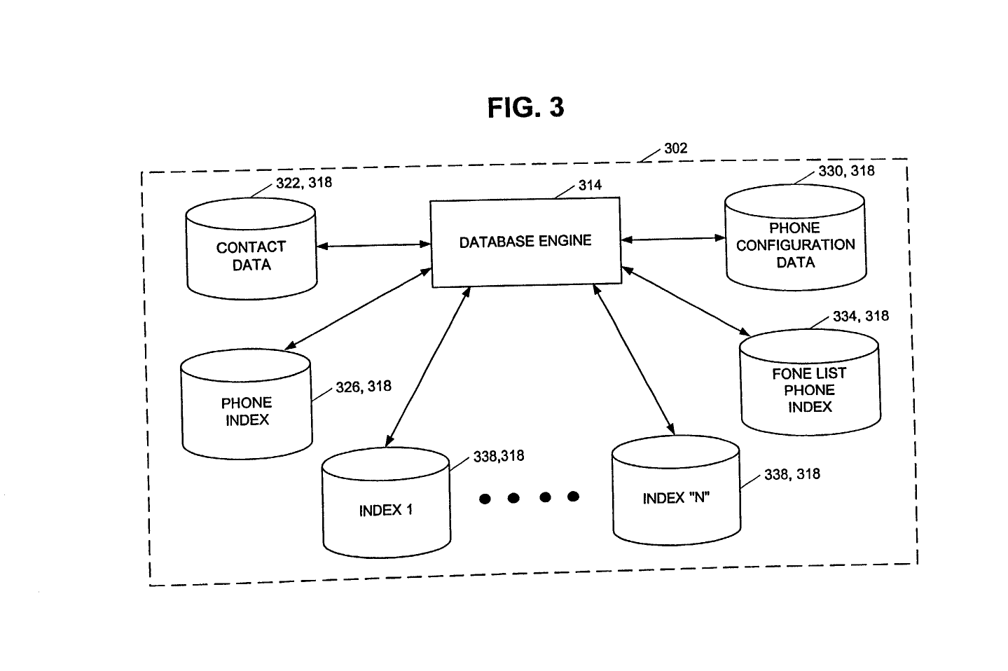

FIGS. 2 and 3 display logic block diagram representations of portions of a program and data domain 290 of the contact management system 100. The program and data domain 290 comprises a multi-tasking, virtual operating system 294, in addition to the contact management application 116 which resides on the data storage device 148 of the computer system 112. The computer system's central processing unit 124 executes the software of the contact management application 116 in cooperation and communication with the multi-tasking, virtual operating system 294 (and uses, among other operating system capabilities, the serial communication capabilities provided by the operating system 294) and employs the system's random access memory 128 for temporary software and data storage. One example of a multi-tasking, virtual operating system 294, acceptable in accordance with the preferred embodiment, is the Windows 95® operating system available from Microsoft Corporation of Redmond, Wash.

The contact management application 116 logically comprises a main module 298, a database system 302, a user interface 306, and a communication interface 310. Note that the arrows of FIGS. 2 and 3 indicate the communication of data and interaction between the components of the contact management application 116. The main module 298 includes a main process 1000, described below, which initiates and terminates operation of the application 116 including: the restoration of application parameters (for example, parameters which define the currently selected contact, the currently selected handset, and the currently selected fone list) to the values which the parameters had when the application 116 was last run; the setting of application parameters to default values if no previous value of the parameters exists; and, the startup of the database system 302 and the user interface 306. The user interface 306 comprises an application window 402 having a plurality of controls (i.e., menus, buttons, list boxes, tabs, text boxes, and other types of graphical user interface controls) and a plurality of software procedures which couple to the controls. The computer system's central processing unit 124 executes the software procedures in response to user interaction with the controls via the pointing device 188 and keyboard 192. Operation of the main module 298 and the user interface 306 are described in more detail below.

The communication interface 310 comprises a plurality of device drivers with each device driver enabling the communication of data between the computer management application 116 and a single, specific type of wireless handset 104. Each device driver includes handset-specific software (referred to herein as device driver software) which provides a common, virtual interface to the other software components of computer management application 116 so that the other software components interact with all device drivers using the same high-level, commands and/or requests of the virtual interface. The device driver software, upon receipt of a high-level command/request from another software component of the application 116, constructs at least one low-level command, using the protocol of the wireless handset 104 with which the device driver software is designed to interact, which is necessary to provide the function commanded/requested by the other software component of the application 116. The device driver software transmits the low-level command, together with any necessary data, to the wireless handset 104 through the computer system's serial interface 180 using appropriate calls to the virtual operating system's serial communication application program interface (API). In response to the receipt of data from the serial interface 264 of the wireless handset 104 and via the virtual operating system's serial communication API, the device driver software formats the data into a form suitable for return communication to the other commanding/requesting application software component.

During operation, the computer management application 116 determines which device driver to employ when it desires communication with a handset 104 connected to the computer system 112 and loads the appropriate device driver into random access memory 128. The computer management application 116 interacts with the virtual interface, as described herein, to communicate data with the wireless handset 104. Once communications are complete, the application 116 unloads the device driver from the random access memory 128.

The database system 302, according to the preferred embodiment and as seen in FIG. 3, comprises a database engine 314 and a plurality of data files and tables 318 (i.e., which reside on data storage device 148) which include a contacts data file 322, phone index tables 326, a phone configuration data file 330, fone list phone index tables 334, and a plurality of other index tables 338 that enable improved access to data of the contacts and phone configuration data files 322, 330. The database engine 314 includes software residing on data storage device 148 which, upon execution by the computer system's central processing unit 124 manages access to the plurality of data files and tables, including performance of the following functions: (i) receiving of data from the other application software components and storing of the received data in the appropriate data files and tables on data storage device 148; (ii) retrieval of data requested by other application software components from the plurality of data files and tables on data storage device 148 and communication of the retrieved data to the requesting other application software components; and, (iii) updating of all index tables, as necessary.

The contacts data file 322 comprises a plurality of records with each record being associated with a single contact. According to the preferred embodiment, each record includes the following fields: business address city, business address country, business address county, business address postal code, business address street, business country code, business fax country code, business fax phone number, business phone number, business type, company name, contact identifier, department name, first name, full name, home address city, home address country, home address county, home address postal code, home address street, home country code, home fax country code, home fax phone number, home phone number, last name, mobile country code, mobile phone number, name, pager country code, pager phone number, position, and title. Two contact index tables of the plurality of data files and tables 318, associated with the contacts data file 322, are maintained and employed by the database engine 314 to enable the retrieval of contact records from the contacts data file 322 in an order selected at run-time by a user of the contact management system 100. The first contact index table stores contact identifiers in an order sorted first by the contact's last name and then by the contact's first name. The second contact index table stores contact identifiers in an order sorted first by the contact's first name and then by the contact's last name. Note that each contact index table stores only one record for each contact maintained by the system 100.

The phone index tables 326 stores a plurality of records with each record uniquely corresponding to a single voice telephone number of any contact within the contacts data file 322. Each record of a phone index table comprises a phone identifier which includes a contact identifier and an enumerated value indicating the type of telephone represented by the record (i.e., Office, Home, or Mobile). The database engine 314 maintains two phone index tables 326 with a first table 326 having phone identifiers sorted first by the corresponding contact's last name and then by the corresponding contact's first name and a second table 326 sorted first by the corresponding contact's first name and then by the corresponding contact's last name. Note that the phone index tables 326 include no phone identifiers for fax numbers.

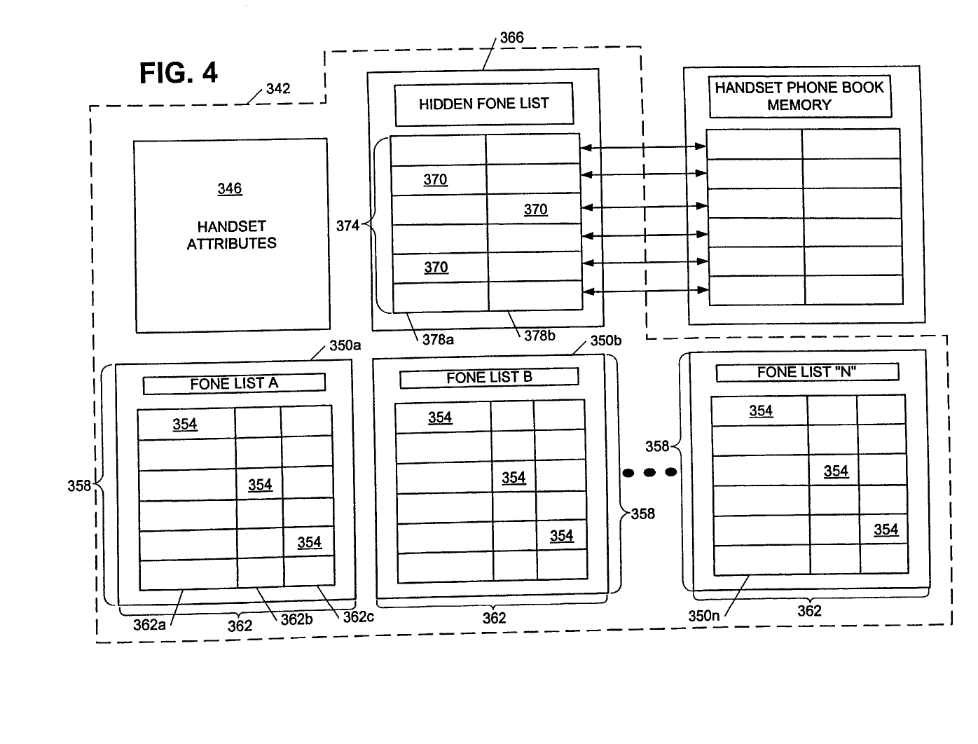

FIG. 4 pictorially displays a phone configuration 342 which the database system's phone configuration data file 330 (see FIG. 3) stores for each wireless handset 104 that a user has selected for interaction with the system 100. Each phone configuration 342 includes memory attribute data 346 which describes each type of memory installed in a respective selected handset 104. Memory attribute data 346 includes the total number of entry locations (i.e., rows or row locations) available in the handset 104 for the storage of entries each having a name portion and telephone number portion, the maximum number of characters storable in the name portion of an entry location, the maximum number of characters storable in the telephone number portion of an entry location, and a list of valid characters usable in the telephone number portion of an entry location. Together, the parameters and limitations specified by the memory attribute data 346 define a wireless handset's “personality”.

Each phone configuration 342 also includes one or more named fone lists 350 (i.e., different fone lists 350 are indicated in FIG. 4 by different alpha subscripts) which are configured by a user of the contact management system 100 through the user interface 306. Each named fone list 350 includes a plurality of memory cells 354 arranged in a matrix configuration having a plurality of rows 358 (i.e., row locations) with each row 358 having a plurality of columns 362. Each row 358 of the plurality of rows stores a voice telephone entry (i.e., no fax telephone entries) of the respective named fone list 350. The columns 362a, 362b, 362c of each row 358 respectively store (and, hence, a voice telephone entry includes) a contact's short name (i.e., an abbreviated form of the contact's full name including a telephone type indicator which indicates the type of phone to which the entry corresponds), a telephone number associated with the contact's short name, and a phone identifier providing linkage to a record in each of the phone index tables 326. Because more than one named fone list 350 is storable for each selected wireless handset 104, a user can maintain, for example, a first named fone list 350a which includes voice telephone entries for contacts present in a first country, a second named fone list 350b which includes voice telephone entries for contacts present in a second country, a third named fone list 350c which includes voice telephone entries for contacts that the user may desire to call when the user is in town, and a fourth named fone list 350d which includes voice telephone entries for contacts that the user may desire to call when the user is out of town. Note that the same voice telephone entry is includeable in more than one named fone list 350 at the same time. Note also that the maximum number of rows 354 (i.e., the maximum number of entries) and the respective maximum sizes of the short names and voice telephone numbers storable in each named fone list 350 are the identical to the same limitations of the phone book memory 244 of the wireless handset 104 (i.e., as stored in the memory attribute data 346) for which the named fone list 350 stores voice telephone entries. Furthermore, note that a number of rows 358 of the plurality of rows 358 are often not used to store voice telephone entries, thereby creating the possibility that unused, or empty, rows 358 may be interspersed between rows 358 which store voice telephone entries.

Each phone configuration 342 additionally comprises an unnamed, or “hidden”, fone list 366 which is inaccessible to a user of the contact management system 100 and which, at any given time, stores a replica of the voice telephone entries which were last downloaded (as described below) to the wireless handset 104 associated with the phone configuration 342. The hidden fone list 366 includes a plurality of memory cells 370 which define a matrix configuration having a plurality of rows 374 (i.e., a plurality of row locations) and a plurality of columns 378 that mimics the phone book memory 244 of the associated wireless handset 104. Each row 374 of the plurality of rows 374 stores data associated with one voice telephone entry. A first column 378a of each row 374 stores a short name of the voice telephone entry and a second column 378b of each row 374 stores a voice telephone number of the respective voice telephone entry. The maximum number of rows 374, the maximum number of characters allowed for the short name (i.e., allowed for the first column 378a), and the maximum number of characters allowed for the voice telephone number (i.e., allowed for the second column 378b) of the hidden fone list 366 are identical to that of the phone book memory 244 of the respective wireless handset 104. Note that, as indicated by the arrows of FIG. 4, each row 374 of the hidden fone list 366 corresponds in one-to-one correspondence with the identically positioned row 256 of the respective handset's phone book memory 244. However, it is possible for the contents (i.e., short name and voice telephone number) of a given row 374 of the hidden fone list 366 to be different than the contents of the identically positioned row 256 of the respective handset's phone book memory 244 due to user modification of the phone book memory 244 through the handset's user interface 270. Note also that some of the rows 374 of the plurality of rows 374 are often not used to store voice telephone entries, thereby enabling the presence of unused, or empty, rows 374 between rows 374 currently storing voice telephone entries.

Referring back to FIG. 3, the database engine 314 maintains a fone list phone index table 334 for each named fone list 350. Each fone list phone index table 334 comprises a plurality of records each having a phone identifier (i.e., a contact identifier and an enumerated value indicating the type of telephone represented by the record (i.e., Office, Home, or Mobile)) and a row location (i.e., or entry location) in a respective named fone list 350 at which a voice telephone entry associated with the phone identifier resides. Use of a fone list phone index table 334 enables the contact management system 100 to determine whether a named fone list 350 requires updating when a user modifies a voice telephone number associated with a contact and further enables the system 100 to rapidly determine the row location in the respective named fone list 350 where the voice telephone number resides.

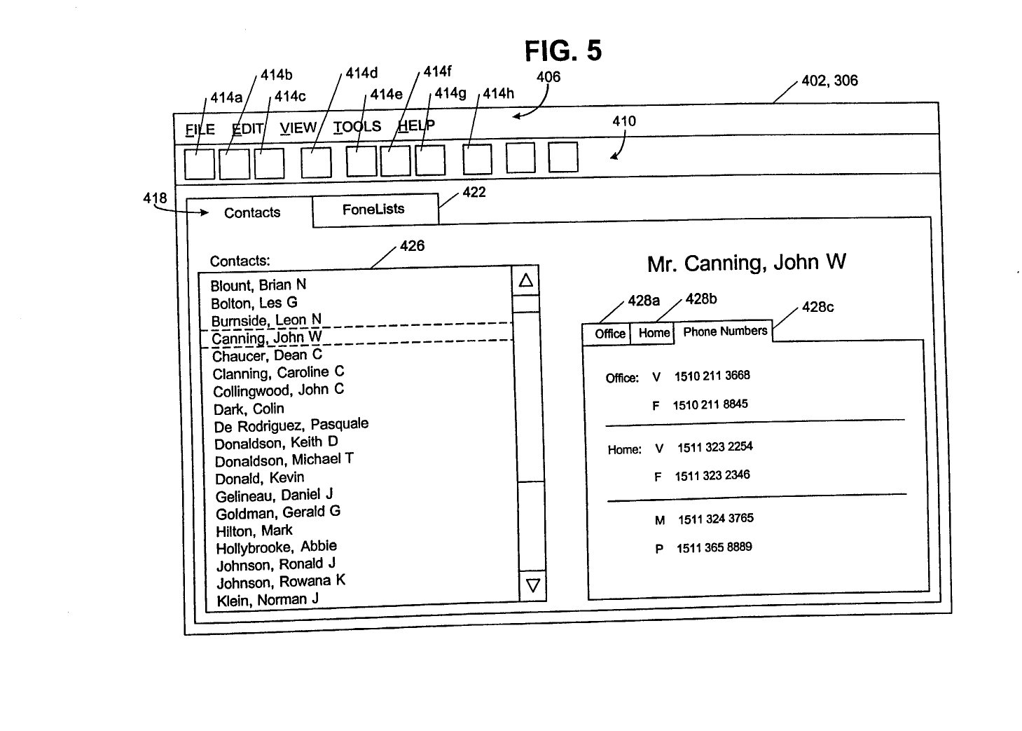

In accordance with the preferred embodiment and as pictorially illustrated in FIG. 5, the application window 402 of the user interface 306 comprises a menu bar 406 having a plurality of menu options (i.e., File, Edit, View, Tools, and Help) which, when selected by a user, display respective pull-down menus that enable the user to instruct the system 100 to perform a variety of functions including modification of the sort order employed by the system 100 to display contact names (i.e., last name first or first name first). A first button control 414a of the plurality of button controls 414 has an associated new contact procedure 1600, described below, which enables a user to input information for a contact (including the contact's name, voice telephone numbers, and other information stored by the contacts data file 322) not already in the contact management system 100. Note that a similar procedure which enables a user to edit information for a contact (also referred to herein as “contact information” or “contact data”) is accessible to a user from the Edit option of menu bar 406. A second button control 414b of the plurality of button controls 414 has an associated new handset configuration procedure 1800, described below, which allows a user to prepare the system 100 for interaction with a new wireless handset 104. A third button control 414c of the plurality of button controls 414 has an associated new fone list procedure 1900, described below, which enables a user to create a new named fone list 350 in the phone configuration 342 for the currently selected wireless handset 104. A fourth button control 414d of the plurality of button controls 414 has an associated “Delete” software procedure which enables a user to delete a currently selected contact, phone configuration 342, named fone list 350, or fone list entry. A fifth button control 414e of the plurality of button controls 414 has an associated toggle download status procedure 2000, described below, which enables a user to select or deselect a voice telephone entry of a displayed named fone list 350 for downloading to a connected handset 104. A sixth button control 414f of the plurality of button controls 414 has an associated tag all procedure 2100 described below, which enables a user to select, or tag, all of the voice telephone entries of a displayed named fone list 350 for downloading to a connected handset 104 by setting the download status indicator of each voice telephone entry. A seventh button control 414g of the plurality of button controls 414 has an associated untag all procedure 2200, described below, which enables a user to deselect, or untag, all of the voice telephone entries of a displayed named fone list 350 from being downloaded to a connected handset 104 by clearing the download status indicator of each voice telephone entry. An eighth button control 414h of the plurality of button controls 414 has an associated download procedure 2300, described below, which causes the downloading of the voice telephone entries of a displayed named fone list 350 that have their download status indicators set.

The application window 402, as seen in FIG. 5, additionally comprises a contacts tab control 418 in the foreground and a fone lists tab control 422 in the background. The contacts tab control 418 includes a contacts name control 426 which displays the names of contacts currently stored in the contacts data file 322 in an order (i.e., last name first or first name first) selected by the user through use of the Tools option of menu bar 406. The system 100 populates the contacts name control 426 according to a populate contacts name control procedure 1300 described below. The contacts tab control 418 also includes a plurality of contact detail tab controls 428 which display contact information from the contacts data file 322 for the currently selected, or highlighted, (i.e., selected through use of the computer system's pointing device 188) contact name in the contacts name control 426. Note that contact detail tab control 428a displays contact information related to the contact's office, contact detail tab control 428b displays contact information related to the contact's home, and contact detail tab control 428c displays telephone numbers for the currently selected contact including, voice and facsimile telephone numbers for the contact's office and home, a mobile voice telephone number, and a pager telephone number.

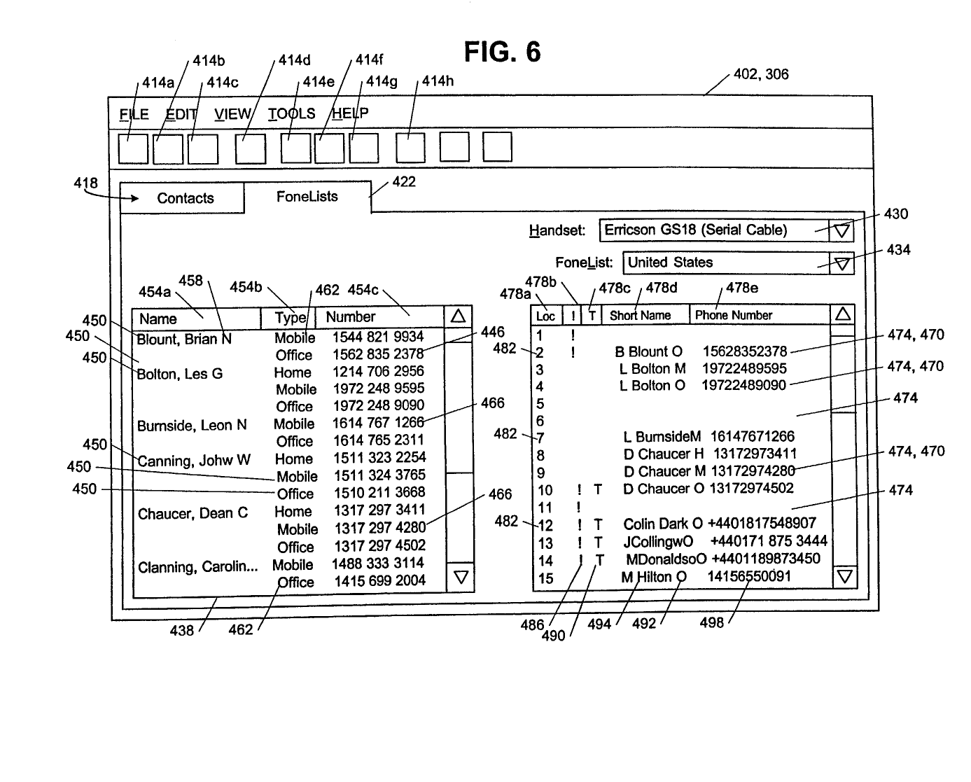

FIG. 6 displays the application window 402 of the user interface 306 with the fone lists tab control 422 in the foreground and the contacts tab control 418 in the background. The fone lists tab control 422 comprises a handset name control 430 which displays the name of the currently selected phone configuration 342 (also referred to herein as a “handset configuration 342”) and the names of other selectable phone configurations 342. The names of the other selectable phone configurations 342 correspond to phone configurations 342 which were previously setup by the user through execution of the new handset configuration procedure 1800 in response to the user's prior selection of the second button control 414b. The handset name control 430 has an associated select handset procedure 2400 which the computer system 112 executes, as described below, when a user selects a handset configuration 342 from control 430.

The fone lists tab control 422 also comprises a fone list name control 434 which displays the name of the currently selected named fone list 350 and the names of other selectable named fone lists 350 of the currently selected handset configuration 342. The names of the other selectable named fone lists 350 correspond to named fone lists 350 previously setup by the user through selection of the third button control 414c and execution of the associated new fone list procedure 1900. The fone list name control 434 has an associated select fone list procedure 2500 which the computer system 112 executes, as described below, when a user selects a named fone list 350 from control 434.

The fone lists tab control 422 additionally comprises a voice telephone numbers control 438 and a fone list details control 442. The voice telephone numbers control 438 displays a plurality of voice telephone number entries 446 which are selectable for inclusion in a named fone list 350 by a user employing the pointing device 188 to select desired entries. The voice telephone numbers control 438 displays the voice telephone number entries 446 using a matrix configuration having a plurality of rows 450 and a plurality of columns 454. Each row 450 corresponds to a voice telephone number entry 446 and includes a contact's name 458 in a first column 454a if the row 450 represents the first voice telephone number entry 446 in the control 438 which is associated with that contact (i.e., otherwise, the first column 454a is blank), a telephone type indicator 462 associated with the voice telephone number entry 446 in a second column 454b, and a voice telephone number 466 associated with the voice telephone number entry 446 in a third column 454c. The user interface 306 populates the voice telephone numbers control 438 with voice telephone number entries 446 from the contacts data file 322 through use of a populate voice telephone numbers control procedure 1400 described below. Note that the voice telephone numbers control 438 displays only voice telephone numbers and does not display any facsimile or pager telephone numbers.

The fone list details control 442 displays the current fone list entries 470 of the currently selected named fone list 350 which is identified by the fone list name present in the fone list name control 434. The fone list details control 442 displays the fone list entries 470 as a plurality of rows 474 with each row 474 (i.e., or row location) corresponding in a one-to-one relationship with a fone list entry 470 of the currently selected named fone list 350 (and, hence, in a one-to-one relationship with the similarly positioned row 358 of the named fone list 350 as stored in the fone list's respective phone configuration 342). A user adds a fone list entry 470 to the displayed named fone list 350 by “selecting” a voice telephone number entry 446 from the voice telephone numbers control 438 with the pointing device 188, “dragging” the selected voice telephone number entry 446 over the fone list details control 442, and “dropping” the selected voice telephone number entry 446 on a desired empty row 474 of the control 442 (the process being also referred to herein as the “selecting, dragging, and dropping process”). It is understood that the scope of the present invention includes other methods of selecting a voice telephone number entry 446 and adding that entry 446 to the fone list details control 442. Note that the user interface 306 populates the fone list details control 442 with fone list entries 470 from the currently selected named fone list 350 upon startup and selection of a new named fone list 350 from fone list name control 434 through use of a populate fone list details control software procedure 1500 described below.

Each row 474 of the fone list details control 442 includes a plurality of columns 478 which display information pertaining to the row's respective fone list entry 470. A first column 478a of a row's plurality of columns 478 displays a row number indicator 482 which identifies to the user the relative position of a row's respective fone list entry 470 in the named fone list 350. A second column 478b of a row's plurality of columns 478 displays a visual representation of a synchronization status indicator 486 which indicates to the user whether the information (i.e., the short name and voice telephone number) of the row's respective fone list entry 470 is identical to that previously downloaded to the corresponding row 256 of the phone book memory 244 of the currently selected wireless handset 104 identified by the name appearing in the handset name control 430. If the information is not identical because a change in the information has been made by a user through the contact management application 116 (thereby causing the synchronization status indicator 486 to be set), the fone list details control 442 displays a representative symbol (i.e., an exclamation mark in FIG. 6) in the second column 478b the row 474. If the information is identical (i.e., the synchronization status indicator 486 is clear), the fone list details control 442 displays nothing in the second column 478b of the row 474.

A third column 478c of a row's plurality of columns 478 displays a visual representation of a download status indicator 490 which indicates to the user whether the row's respective fone list entry 470 is to be downloaded to the corresponding row 256 of the phone book memory 244 of the currently selected wireless handset 104 (i.e., identified by the handset name control 430) when a user selects button control 414h. If the row's respective fone list entry 470 is to be downloaded, the entry's download status indicator 490 has been previously set by the user and the fone list details control 442 displays a representative symbol (i.e., a “T” in FIG. 6) in the third column 478c of the row 474. If the row's respective fone list entry 470 is not to be downloaded, the entry's download status indicator 490 has been previously cleared by the user (or the application 116) and the fone list details control 442 displays nothing in the third column 478c of the row 474.

A fourth column 478d of a row's plurality of columns 478 displays a short name 494 corresponding to the full name of the contact to which the row's respective fone list entry 470 pertains. The short name 494 includes an abbreviated form of the contact's full name and an abbreviated telephone type indicator (i.e., “O” for office, “H” for home, and “M” for mobile) which identifies the type of voice telephone number corresponding to the row's respective fone list entry 470. The user interface 306 creates the short name 494 when the row's respective fone list entry 470 is added to the named fone list 350 by a user employing the “selecting, dragging, and dropping process” described above. Creation of the short name 494 occurs during execution of a “Select Voice Telephone Entry” software procedure (described below) which executes immediately after the user “selects, drags, and drops” the row's respective fone list entry 470 onto the fone list details control 442 as described above.

A fifth column 478e of a row's plurality of columns 478 displays a voice telephone number 498 corresponding to the contact to which the row's respective fone list entry 470 pertains. The voice telephone number 498 is the appropriate telephone number for the type of telephone indicated by the abbreviated telephone type indicator of the associated short name 494 of the fourth column 478d.

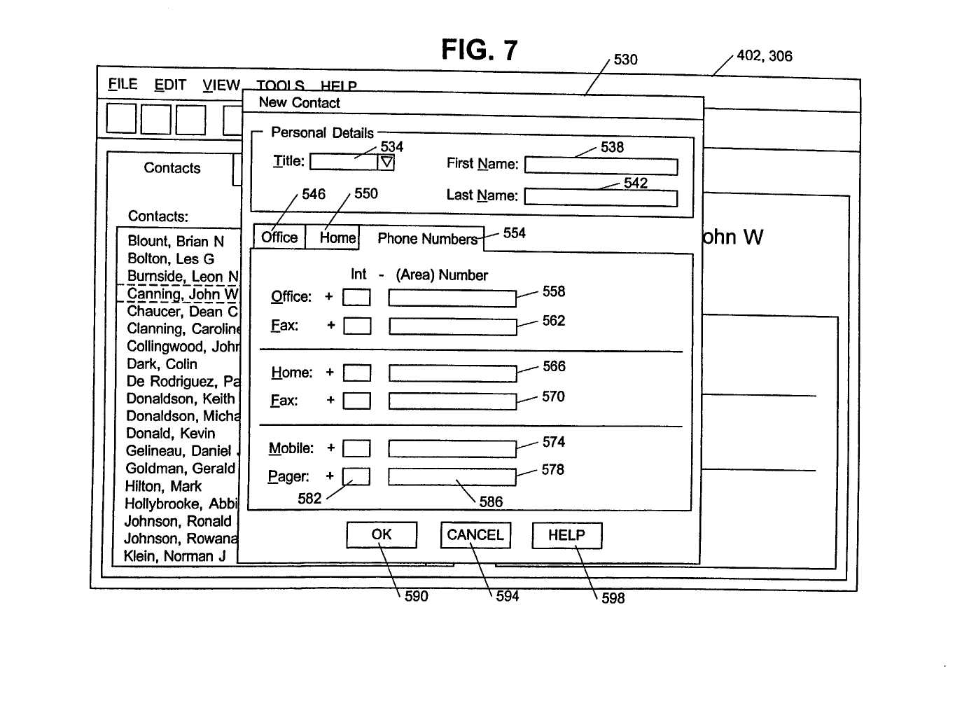

In accordance with the preferred embodiment, the user interface 306 further comprises a new contact dialog box 530 (see FIG. 7) which the user interface 306 displays upon selection of button control 414a by a user to initiate the collection of information pertaining to a new contact and storage of that information in the contacts data file 322. The new contact dialog box 530 includes a title control 534, a first name control 538, and a last name control 542 for receipt of the new contact's title (i.e., Mr., Mrs., Ms., etc.), first name, and last name, respectively. The new contact dialog box 530 also includes an office tab control 546, a home tab control 550, and a phone numbers tab control 554. The office and home tab controls 546, 550 enable the application 116 to receive user input of information related to the new contact's office and home (i.e., office address, home address, etc.). The phone numbers tab control 554 enables the application 116 to receive telephone numbers from a user for the new contact. The phone numbers tab control 554 includes: an office voice telephone number control 558 for receipt of the new contact's office voice telephone number; an office facsimile telephone number control 562 for receipt of the new contact's office facsimile telephone number; a home voice telephone number control 566 for receipt of the new contact's home voice telephone number; a home facsimile telephone number control 570 for receipt of the new contact's home facsimile telephone number; a mobile voice telephone number control 574 for receipt of the new contact's mobile voice telephone number; and, a pager telephone number control 578 for receipt of the new contact's pager telephone number. Each control 558, 562, 566, 570, 574, 578 includes an international dialing prefix portion 582 and an area code/number portion 586. The phone numbers tab control 554 further includes an OK button control 590, a Cancel button control 594, and a Help button control 598.

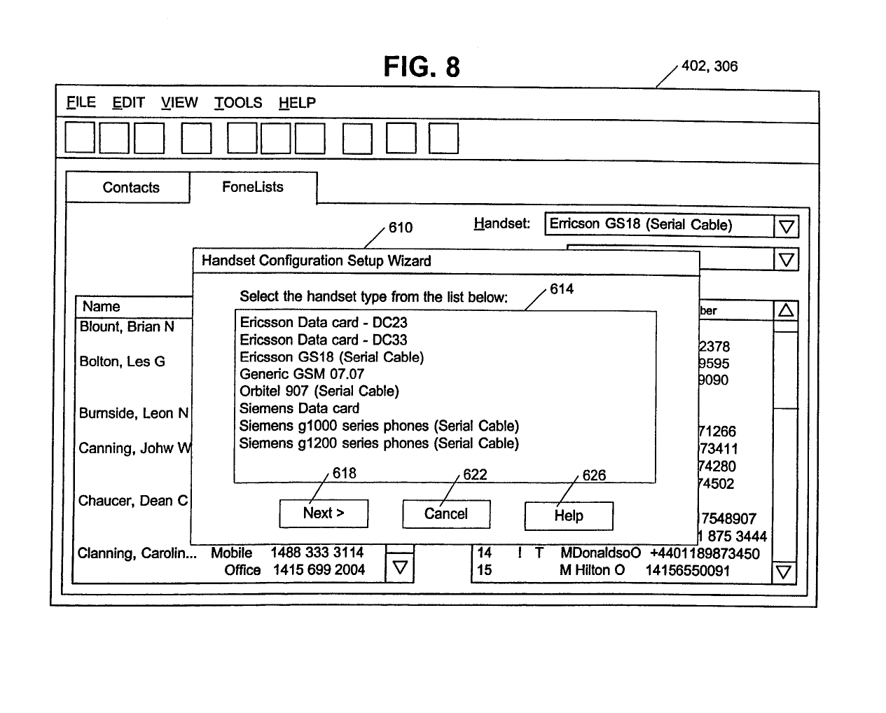

FIG. 8 pictorially depicts a select handset type dialog box 610 of the user interface 306 which the user interface 306 displays upon selection of button control 414b by a user to initiate the creation of a new phone configuration 342 in the phone configuration data file 330. The select handset type dialog box 610 comprises a handset type control 614 which displays a plurality of available handset types for selection of one by a user. The select handset type dialog box 610 further comprises a Next button control 618, a Cancel button control 622, and a Help button control 626.

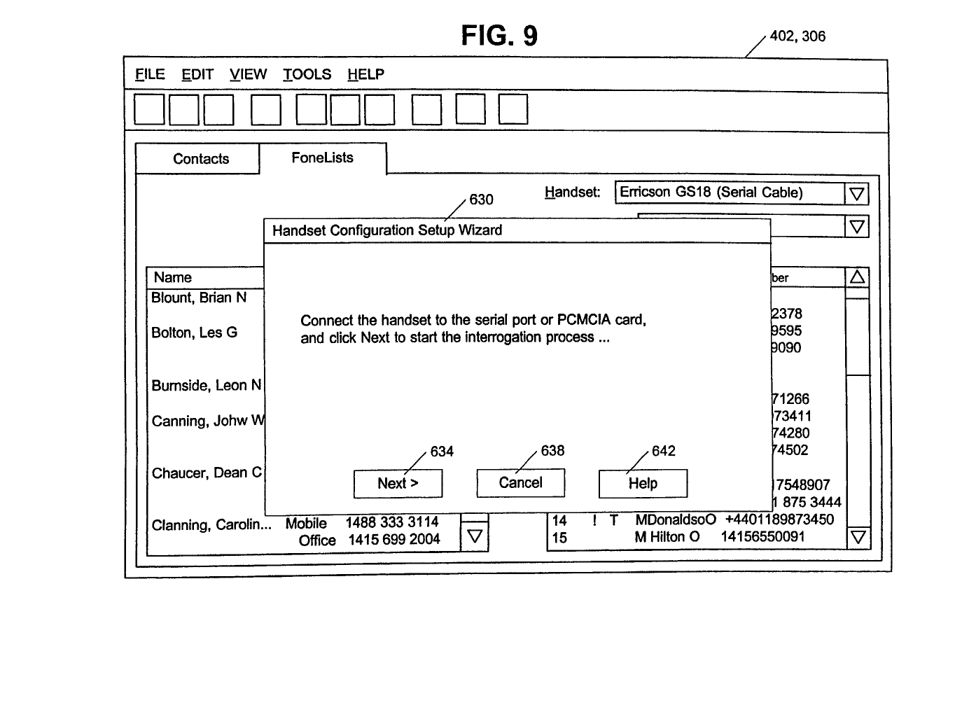

The user interface 306 further comprises a handset connection request dialog box 630 as seen in FIG. 9. The handset connection request dialog box 630 includes an instruction instructing a user to connect a wireless handset 104 (i.e., of the handset type selected by the user from the select handset type dialog box 610) to the computer system 112. The handset connection request dialog box 630 further includes a Next button control 634, a Cancel button control 638, and a Help button control 642.

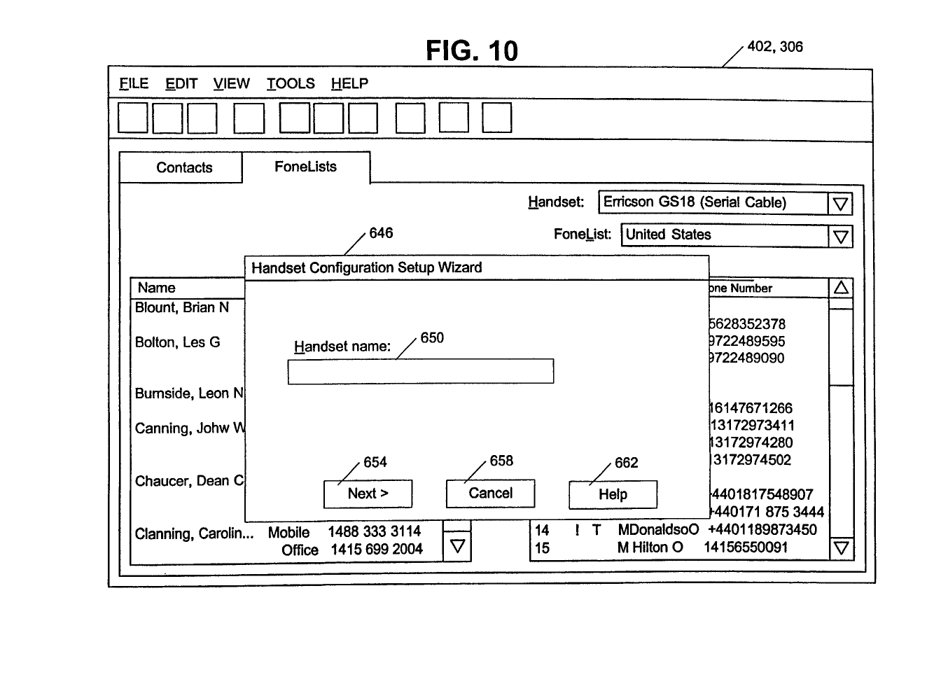

FIG. 10 pictorially illustrates a handset name request dialog box 646 of the user interface 306 which the user interface 306 displays on display device 172 after a connected handset has been interrogated by the application 116. The handset name request dialog box 646 includes a new handset name control 650 which receives a name from the user, via keyboard 192, for the new handset configuration 342. The handset name request dialog box 646 further includes a Next control button 654, a Cancel control button 658, and a Help control button 662.

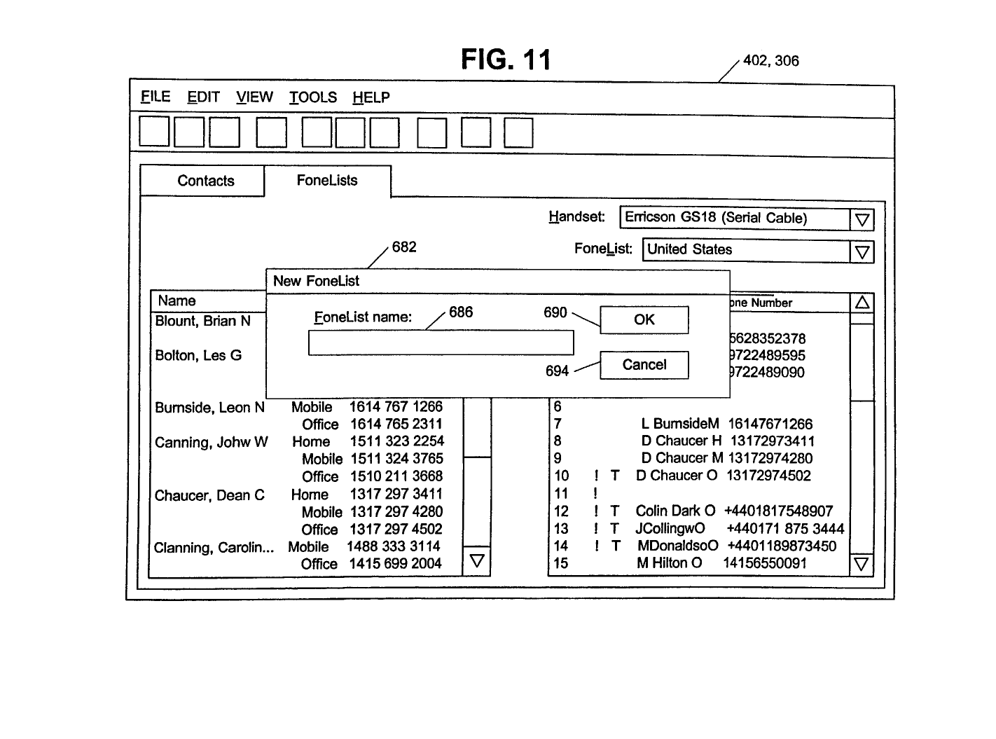

The user interface 306 further comprises a new fone list dialog box 682 pictured in FIG. 11. The new fone list dialog box 682 includes a new fone list name control 686 which receives a new fone list name from the user. The new fone list dialog box 682 further includes an OK button control 690 and a Cancel button control 694.

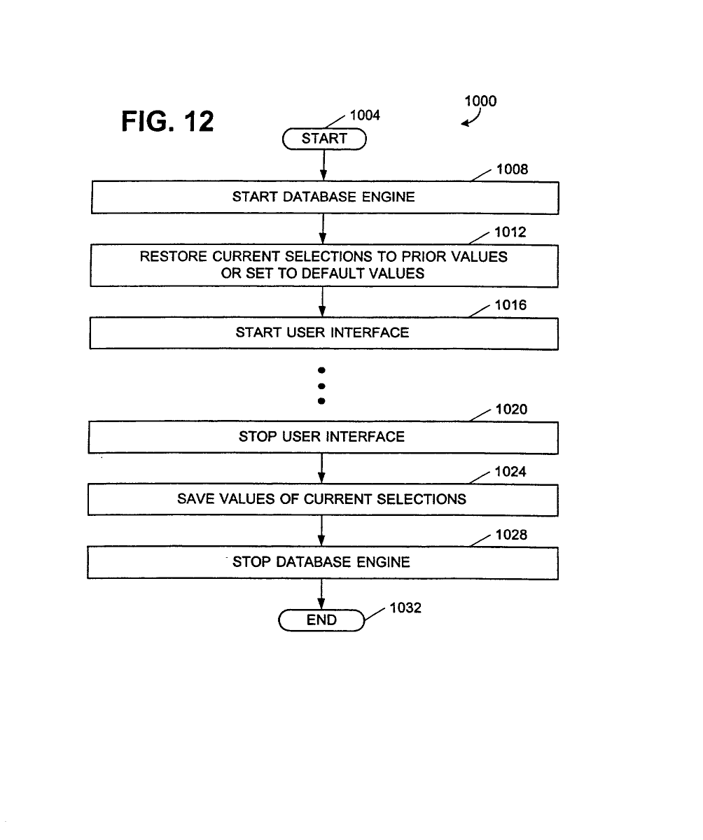

In accordance with a method of the preferred embodiment of the present invention, FIG. 12 displays a main process 1000 of the contact management application 116 which the central processing unit 124 of the contact management system 100 begins to operate in accordance with when the contact management application 116 is initiated by a user at computer system 112. The main process 1000 starts at step 1004 and advances to step 1008 where the central processing unit 124 starts the database engine 1008 to establish connections with the various data files and tables 318 of the contact management application 116. Then, at step 1012, the database engine 1008 retrieves the values of current selections, if any, which were in effect when the application 116 was last run by the user. If any values are retrieved, the central processing unit 124 restores the values of the current selections (including, the currently selected handset configuration 342, the currently selected named fone list 350, and the currently selected sort order for contact names and short names). If no values are retrieved, the central processing unit 124 sets the values of the current selections to default values. Once the values of the current selections have been set, the central processing unit 124 starts the user interface 306 at step 1016. Then, the central processing unit 124 temporarily ceases execution of steps identified by the main process 1000, as indicated by the ellipsis of FIG. 12, until the user initiates exiting of the application 116 by selecting an Exit option from the pull-down menu associated with File option of the menu bar 406. Upon learning that the user desires to exit the application 116, the central processing unit 124, according to the main process 1000, stops the user interface 306 at step 1020. Then, the database engine 314 stores the values of current selections on data storage device 148 at step 1024. Once the values of the current selections are stored, the database engine 314 terminates connections with the various data files and tables 318 and, according to the main process 1000, the central processing unit 124 stops the database engine 314. The central processing unit 124 ceases operation in accordance with the main process 1000 at step 1032.

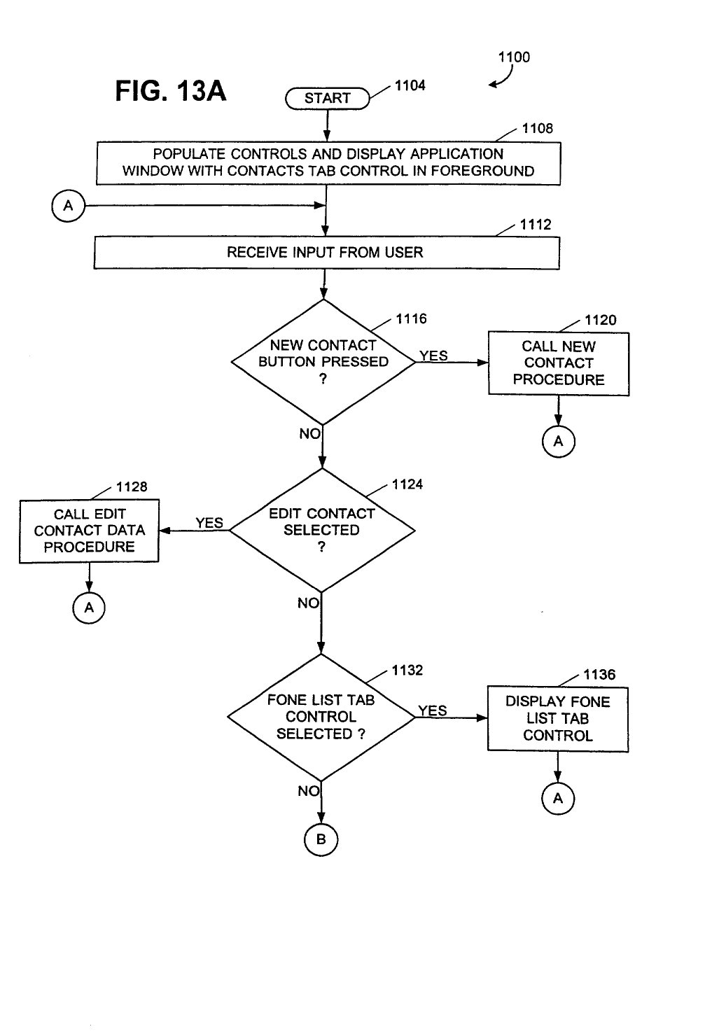

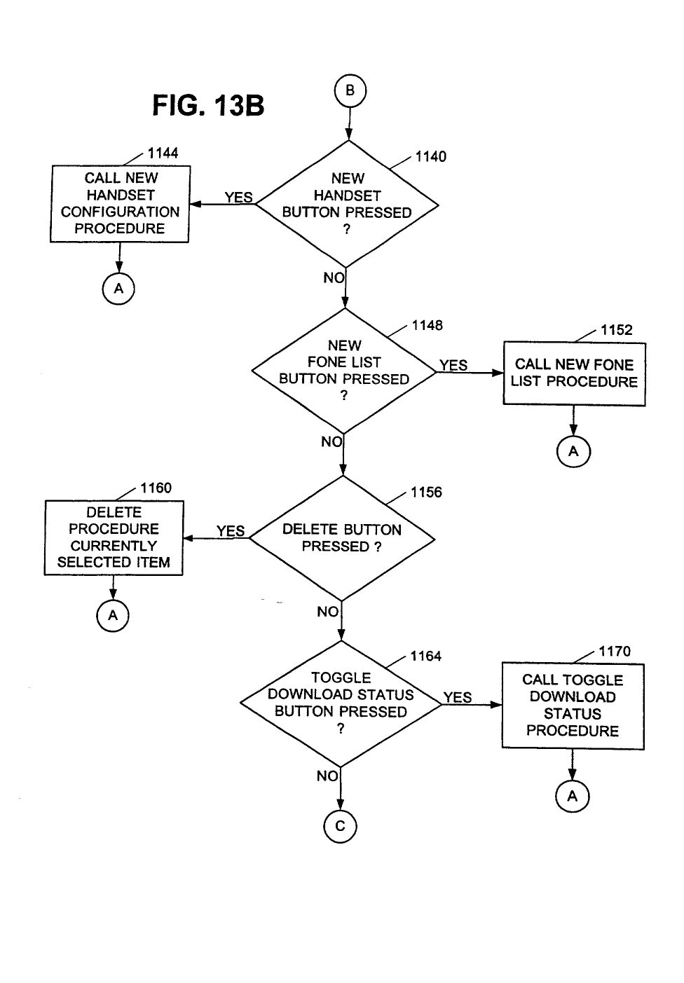

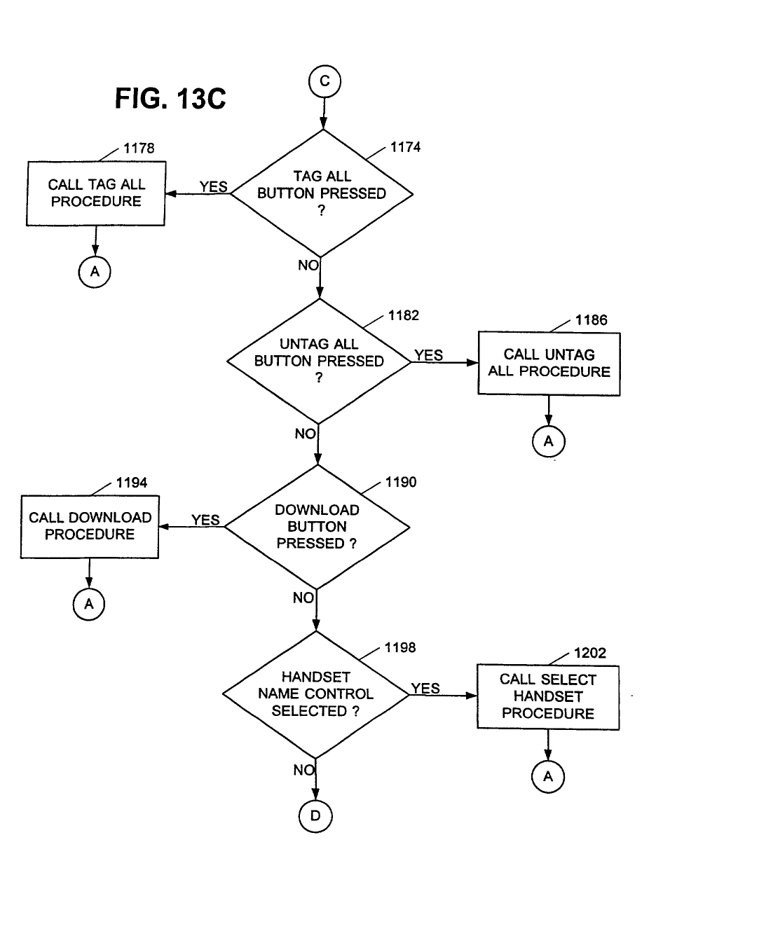

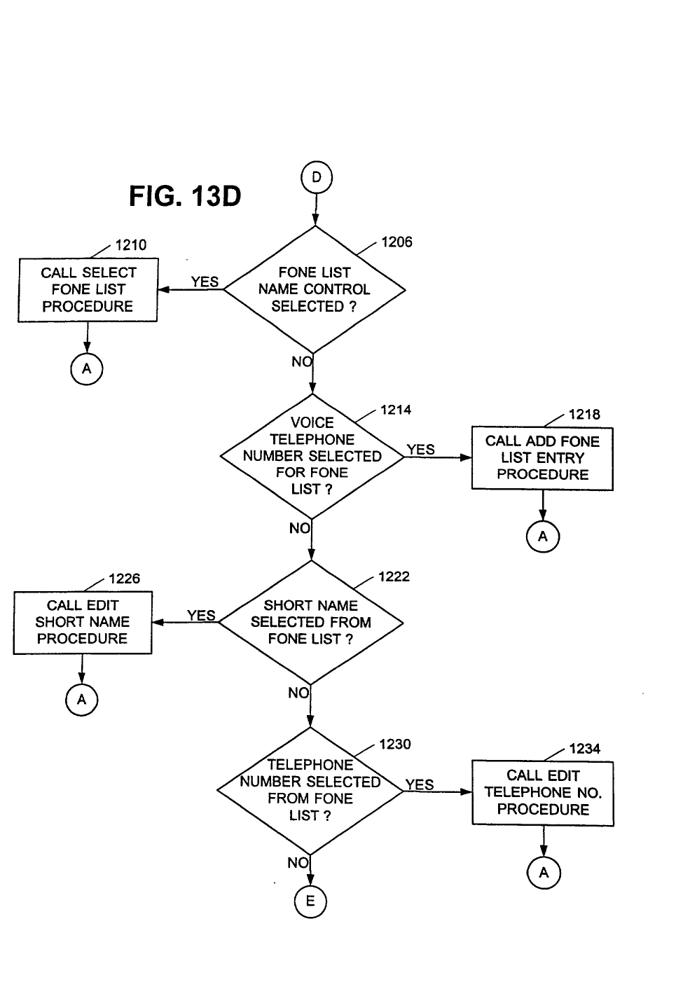

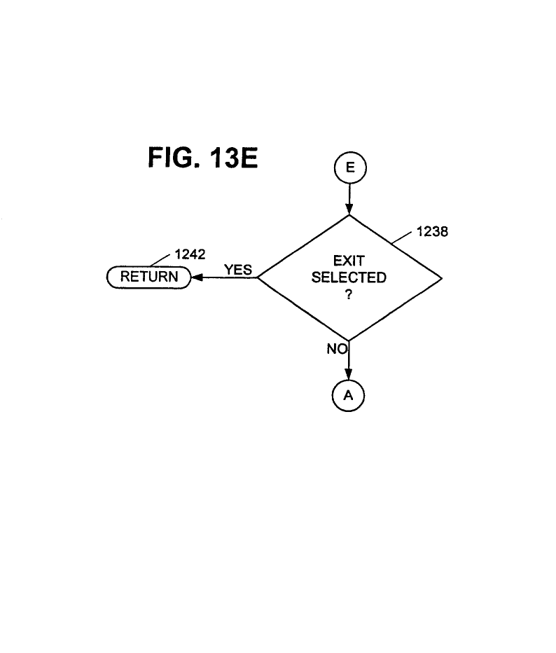

FIG. 13 displays a user interface process 1100 which the central processing unit 124 follows to interface with a user of the contact management application 116. The user interface process 1100 starts at step 1104 and proceeds to step 1108 where the central processing unit 124 operates according to a populate contacts name control procedure 1300, a populate voice telephone numbers control procedure 1400, and a populate fone list details control process 1500 to respectively populate the contacts name control 426, the voice telephone numbers control 438, and the fone list details control 442 of the user interface 306. The central processing unit 124 also populates the various other controls of the user interface 306, if necessary. Once population of the controls is complete, the central processing unit 124 causes the display of application window 402 on display device 172, including the now populated controls. Advancing according to step 1112 of the user interface process 1000, the central processing unit 124 waits until it receives input from a user via the pointing device 188 or the keyboard 192 and, upon receipt of a user input, continues operation according to the user interface process 1100 at step 1116. The central processing unit 124 determines, at step 1116, whether the input received from the user at step 1112 was the pressing of the new contact button control 414a by the user. If so, the central processing unit 124, as directed at step 1120, operates in accordance with the new contact procedure 1600 to collect information pertaining to a new contact and then returns to operation according to process 1100 at step 1112 where it waits for user input. If not, the central processing unit 124 continues to operate according to process 1100 where, at step 1124, the central processing unit 124 determines whether the input received at step 1112 was a selection of the edit contact procedure 1700 from the Edit option of menu bar 406. If so, the central processing unit 124 branches to step 1128 of process 1100 where it is directed to operate according to the edit contact procedure 1700 in order to enable the user to edit the currently selected contact of the contacts name control 426. Upon completion of steps according to the edit contact procedure 1700, the central processing unit 124 returns to the control of the user interface process 1100 and loops back to step 1112 to wait for user input.

If, at step 1124, the central processing unit 124 decides that the user input was not a selection of the edit contact procedure 1700, the central processing unit 124 advances to step 1132 of process 1100 where it ascertains whether the user input was a selection of the fone list tab control 422. If so, the central processing unit 124, at step 1136, brings the fone list tab control 422 to the foreground of the application window 402 and moves the contacts tab control 418 to the background of the application window 402. According to process 1100, the central processing unit 124 then returns to step 1112 of the process 1100 where it waits for input from the user. If, at step 1132, the central processing unit 124 ascertained that the user input was not a selection of the fone list tab control 422, the central processing unit 124 continues operation at step 1140 of process 1100.

At step 1140, the central processing unit 124 determines whether the user input received at step 1112 was the pressing of the new handset configuration button control 414b. If so, the central processing unit 124 operates in accordance with the steps of the new handset configuration procedure 1800 to create a new handset configuration 342 in the phone configuration data file 330 and then returns to operate in accordance with the steps of process 1100 where it waits for user input at step 1112. If not, the central processing unit 124 continues operation according to the user interface process 1100 at step 1148 where it decides whether the user input at step 1112 was the pressing of the new fone list button control 414c. If so, the central processing unit 124 branches to step 1152 of process 1100 where it begins operation according to the steps of the new fone list procedure 1900 in order to create a new named fone list 350 for the currently selected handset configuration 342. Upon completion of the steps of the new fone list procedure 1900, the central processing unit 124 loops back to step 1112 of process 1100 and waits for user input. If not, the central processing unit 124 advances to step 1156 of process 1100 where it ascertains whether the user input received at step 1112 was the pressing of the delete button control 414d. If so, the central processing unit 124 continues operation at step 1160 and causes deletion of the currently selected contact, fone list entry 470, named fone list 350, or handset configuration 342. After causing such deletion, the central processing unit 124 returns to step 1112 of process 1100 where it waits for user input. If not, the central processing unit 124 decides, in accordance with step 1164 of the user interface process 1100, whether the user input was the pressing of the toggle download status button control 414e. If so, the central processing unit 124 branches to step 1170 where it operates according to the steps of the toggle download status procedure 2000 to toggle the download status indicator 490 associated with the currently selected fone list entry 470 before returning to continued operation in accordance with process 1100 at step 1112.

If the central processing unit 124 determines, at step 1164, that the user input was not the pressing of the toggle download status button control 414e, the central processing unit 124 advances to step 1174 of the user interface process 1100 where it ascertains whether the user input was the pressing of the tag all button control 414f. If so, the central processing unit 124 branches to step 1178 where it selects all of the fone list entries 470 of the named fone list 350 currently displayed in the fone list details control 442 for downloading to a wireless handset 104 in accordance with the tag all procedure 2100. After selecting all of the fone list entries 470, the central processing unit 124 resumes operation according to the user interface process 1100 and once again waits for user input at step 1112. If not, the central processing unit 124 determines, at step 1182 of process 1100, whether the user input received at step 1112 was the pressing of the tag all button control 414g. If so, the central processing unit 124 begins operation according to the tag all procedure 2100 which causes deselection for downloading of all of the fone list entries 470 of the named fone list 350 currently displayed in the fone list details control 442. Upon completion of the steps of the tag all procedure 2100, operation of the central processing unit 124 continues according to the user interface process 1100 at step 1112 where the central processing unit 124 waits for user input. If the central processing unit 124 ascertains at step 1182 that the user input was not the pressing of the tag all button control 414g, the central processing unit 124 continues execution according to process 1100.

At step 1190 of the user interface process 1100, the central processing unit 124 decides whether the user input received at step 1112 was the pressing of the download button control 414h. If so, the central processing unit 124 operates according to the steps of the download procedure according to step 1194 in order to download, to a connected wireless handset 104, the fone list entries 470 of the named fone list 350 of the fone list details control 442 which have their download status indicators 490 set. After completion of the downloading, the central processing unit 124 continues operation according to the steps of process 1100 and waits for user input at step 1112. If not, the central processing unit 124 advances in accordance with the user interface process 1100 to determine, at step 1198, whether a new handset name was selected by the user from the handset name control 430. If so, the central processing unit 124 begins functioning according to the select handset procedure 2400 at step 1202 in order to set the currently selected handset and to display the fone list entries 470 of a named fone list 350 associated with the phone configuration 342 of the selected handset. Then, the central processing unit 124 resumes operation according to step 1112 of process 1100 where it waits for user input. If not, the central processing unit 124 continues operation according to the user interface process 1100 where, at step 1206, it ascertains whether the fone list name control 434 was selected by the user.

If the central processing unit 124 ascertains, at step 1206, that the fone list name control 434 was selected by the user, the central processing unit 124 performs according to steps identified by the select fone list procedure 2500 to set the currently selected named fone list 350 and to display the fone list entries 470 of the selected named fone list 350 in the fone list details control 442. Upon completion of such steps, the central processing unit 124 again continues operation according to step 1112 of the user interface process 1100. If the central processing unit 124 ascertains, at step 1206, that the fone list name control 434 was not selected by the user, the central processing unit 124 determines at step 1214 of process 1100 whether the user selected, dragged, and dropped a voice telephone number entry 446 of the voice telephone numbers control 438 on an empty row 474 of the fone list details control 442. If so, the central processing unit 124 begins executing according to steps described in the add fone list entry procedure 2600 in order to add the selected voice telephone number entry 446 to the currently displayed named fone list 350. After insertion of the selected voice telephone number entry 446, the central processing unit 124 returns to execution in accordance with the user interface process 1100 at step 1112.

If the central processing unit 124 determines, at step 1214, that the user input does not correspond to the selection, dragging, and dropping of a voice telephone number entry 446, the central processing unit 124 continues operating according to process 1100 and, at step 1222, decides whether the user input was the selection of a short name 494 from the fone list details control 442. If so, according to the steps of the edit short name procedure 2700, the central processing unit 124 enables editing of the selected short name 494 by the user and then loops back to step 1112 of the user interface process 1100 to continue operation. If not, the central processing unit 124 determines, in accordance with step 1230 of process 1100, whether the user input corresponds to the selection of a voice telephone number 498 from a fone list entry 470 displayed by the fone list details control 442. If so, the central processing unit 124 performs steps in accordance with the edit telephone number procedure 2800 to allow the user edit the selected voice telephone number 498. After editing is completed, the central processing unit 124 once again, under the control of the user interface process 1100, waits for user input according to step 1112. If, at step 1230, the central processing unit 124 determines that the user input was not a selection of voice telephone number 498 from a fone list entry 470, the central processing unit 124 advances to step 1238 of process 1100 where it decides whether the user selected an exit option from a pull-down menu associated with the file option of menu bar 406. If so, the central processing unit 124 resumes operation according to the steps of the main process 1000. If not, the central processing unit 124 continues operation in accordance with the steps of the user interface process 1100 at step 1112 where it waits for user input.

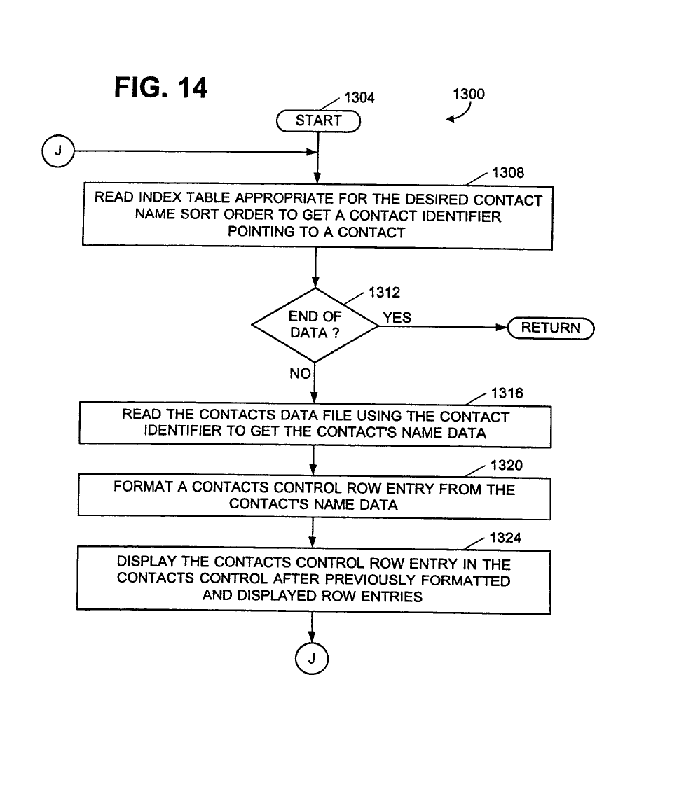

FIG. 14 displays a populate contacts name control procedure 1300 in accordance with the preferred embodiment of the present invention. The central processing unit 124 begins operation according to the steps of procedure 1300 at step 1304 and advances to step 1308 where it causes reading of an index table 338 appropriate for a contact name sort order previously specified by the user in order to get a contact identifier pointing to a contact entry of contacts data file 322. The central processing unit 124 then determines, in accordance with step 1312, whether an end of data condition occurred while reading the appropriate index table 338. If so, all of the contact identifiers have been read and the central processing unit 124 resumes execution according to the steps of the user interface process 1100. If not, the central processing unit 124 causes the reading of the contacts data file 322, using the retrieved contact identifier, to acquire a contact's name data. Then, continuing operation, the central processing unit 124 causes the formatting of a contact name entry for the contacts name control 426 from the contact name data. Next, according to step 1324, the central processing unit 124 causes the display of the formatted contact name entry in the contacts name control 426 after the previously formatted and displayed contact name entries. In accordance with procedure 1300, the central processing unit 124 loops back to step 1308 in order to cause the reading of another contact identifier.

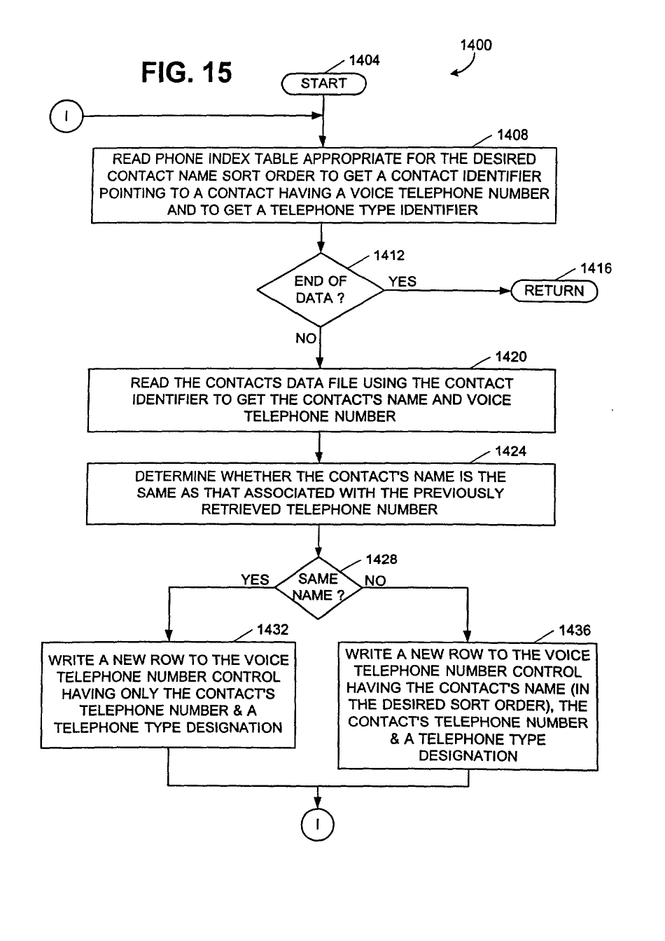

FIG. 15 depicts a populate voice telephone numbers control procedure 1400 in accordance with the preferred embodiment of the present invention. As directed by the steps of procedure 1400, the central processing unit 124 begins execution at step 1405 and progresses to step 1410 where it causes reading of a phone index table 326, appropriate to yield a list of contact voice telephone numbers sequenced in a user-defined sort order, to get a contact identifer and a telephone type identifier. Then, according to step 1412 of procedure 1400, the central processing unit 124 determines whether an end of data condition occurred during reading of the phone index table 326. If so, all of the contact voice telephone numbers have been included in the voice telephone numbers control 438 and the central processing unit 124 resumes execution according to the user interface process 1100. If not, according to step 1420, the central processing unit 124 causes the reading of the contacts data file 322, using the contact identifier retrieved at step 1408, to acquire the associated contact name data and voice telephone number. Next, the central processing unit 124 determines, at steps 1424 and 1428, whether the contact's name is the same as that associated with the previously retrieved voice telephone number. If so, the central processing unit 124 causes the writing of a new row to the voice telephone numbers control 438 where the new row includes only the contact's voice telephone number and a telephone type designation (i.e., which identifies the telephone number to a user as an office, home, or mobile telephone number). Then, according to procedure 1400, the central processing unit 124 loops back to step 1408 where it once again causes the reading of a contact identifier from the appropriate phone index table 326. If the central processing unit 124 determines, at steps 1424 and 1428, that the contact's name is not the same as that associated with the previously retrieved voice telephone number, the central processing unit 124 causes the writing of a new row to the voice telephone numbers control 438 where the new row includes the contact's name, the contact's voice telephone number, and an appropriate telephone type designation. In accordance with the procedure 1400, the central processing unit 124 continues execution at step 1408 and causes the reading of another contact identifier from the appropriate phone index table 326.

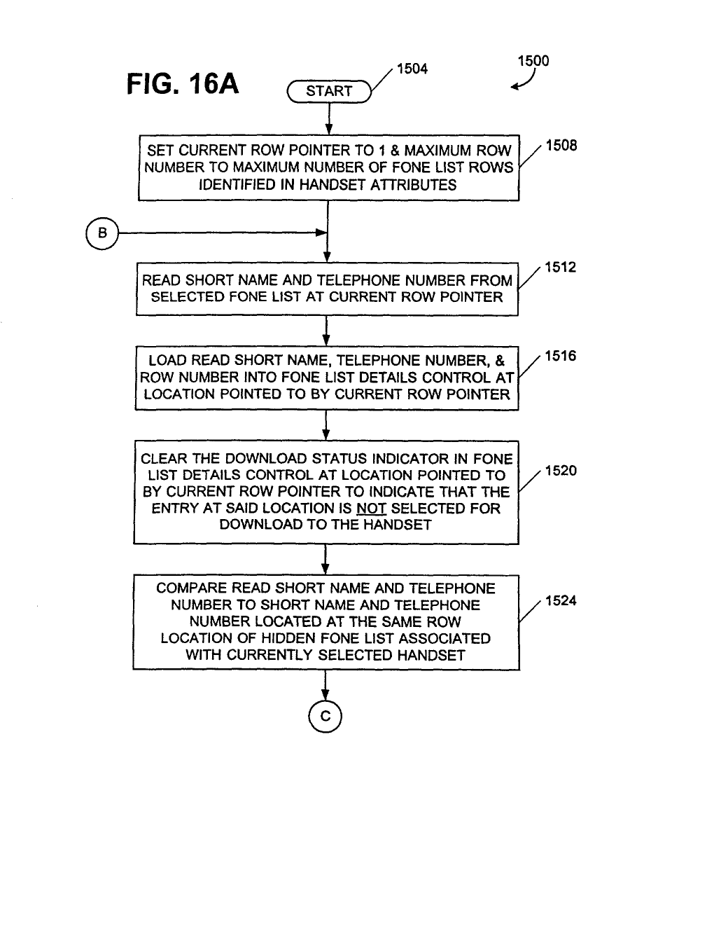

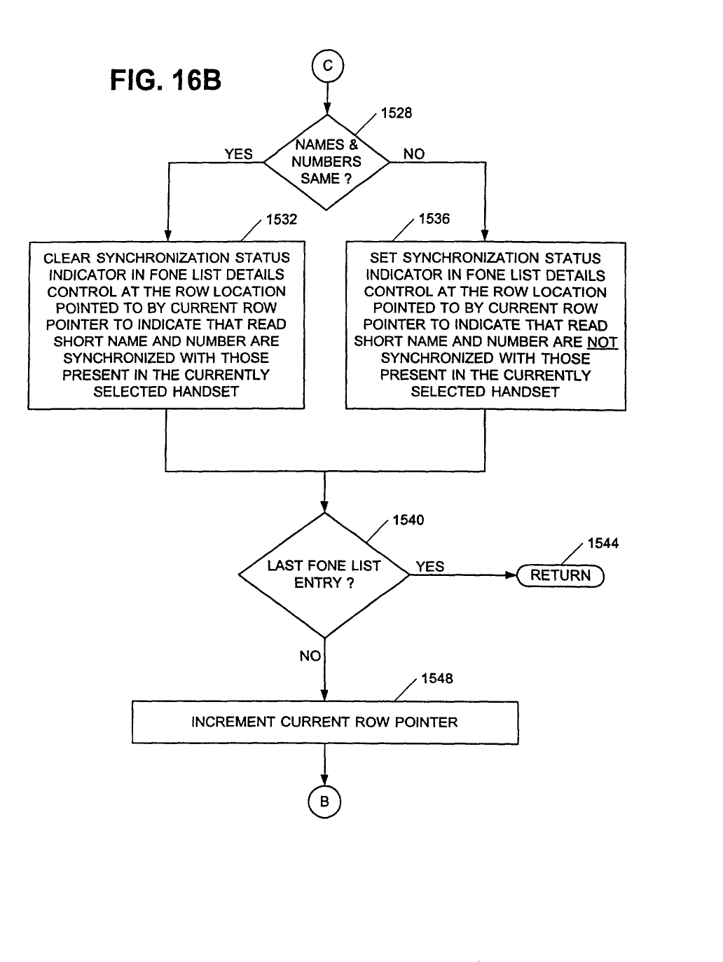

FIG. 16 illustrates a populate fone list details control procedure 1500 in accordance with the preferred embodiment of the present invention. After starting execution according to the steps of procedure 1500 at step 1504, the central processing unit 124 initializes a current row pointer to one and a maximum row number to the maximum number of fone list rows identified in the memory attribute data 346 of the currently selected handset configuration 342. Proceeding according to the procedure 1500 to step 1512, the central processing unit 124 causes the reading of a short name 494 and a voice telephone number 498 from the currently selected named fone list 350 (i.e., as indicated by the name present in the fone list name control 434) of the currently selected handset configuration 342 using the value of the current row pointer to indicate the respective row location 358 to be read. At step 1516, the central processing unit 124 loads the short name 494 and the voice telephone number 498 read from the currently selected named fone list 350 into the fone list details control 442 at a row location 474 identified by the current row pointer. Then, the central processing unit 124, according to step 1520 of the procedure 1500, clears the download status indicator 490 of the loaded fone list entry 470 to indicate that the entry 470 is not selected for downloading to a connected wireless handset 104.

Continuing in accordance with step 1524 of procedure 1500, the central processing unit 124 compares the short name 494 and the voice telephone number 498 read from the currently selected named fone list 350 with the short name and voice telephone number located at the same row location of the hidden fone list 366 of the currently selected handset configuration 342. The central processing unit 124, at step 1528, determines whether the short names and voice telephone numbers compared according to step 1524 are the same. If so, the central processing unit 124 clears the synchronization status indicator 486 of the fone list entry 470 at the row location 474 identified by the current row pointer to indicate that the read short name 494 and voice telephone number 498 are in synchronization with those present in the respective wireless handset 104. If not, the central processing unit 124 sets the synchronization status indicator 486 of the fone list entry at the row location 474 identified by the current row pointer to indicate that the read short name 494 and voice telephone number 498 are not in synchronization with those present in the respective wireless handset 104. Proceeding in accordance with step 1540 of the procedure 1500, the central processing unit 124 decides whether the last fone list entry has been read by comparing the value of the current row pointer to the value of the maximum row number. If the values are identical, the last fone entry has been read and the central processing unit 124 resumes execution according to the process or procedure that directed the central processing unit 124 to perform the steps of procedure 1500. If the values are not identical, the central processing unit 124 increments the value of the current row pointer according to step 1548 and continues execution of procedure 1500 according to step 1512.

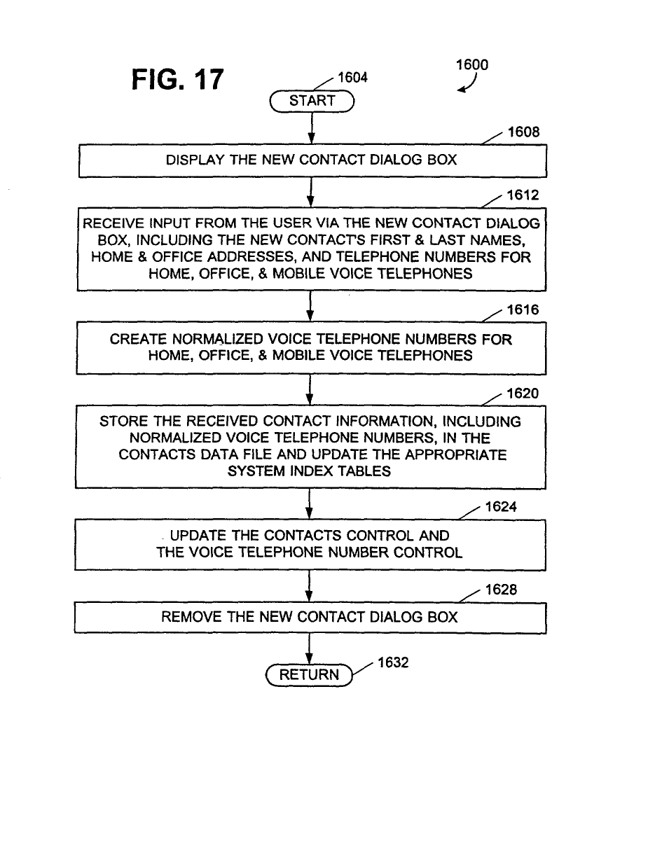

FIG. 17 displays a new contact procedure 1600, according to the preferred embodiment of the present invention, which directs operation of the application 116 when a user selects the new contact button control 414a from button bar 410. After starting execution in accordance with the procedure 1600 at step 1604, the central processing unit 124 advances to perform step 1608 where it displays the new contact dialog box 530 in application window 402 on display device 172. Continuing according to the procedure 1600, the central processing unit 124 receives input from the user via the new contact dialog box 530 and its various controls described above. The input includes, among other information or data, the new contact's first and last names, home and office addresses, and telephone numbers for home, office, and mobile voice telephones. The received telephone number input for each telephone number includes an international dialing prefix portion 582 and an area code/number portion 586. According to step 1616 of the procedure 1600, the central processing unit 124 creates “normalized” voice telephone numbers for each of the received voice telephone numbers by combining the international dialing prefix portion 582 and the area code/number portion 586 for each voice telephone number. Because an international dialing prefix must be dialed when a user of a wireless handset 104 is not present within the user's “local” dialing territory or zone, the “normalized” voice telephone numbers, when downloaded to a wireless handset 104, enable a user of the contact management application 116 to dial a contact from anywhere in the world on his wireless handset 104 without having to remember and enter, using the handset's user interface 270, an international dialing prefix.

The central processing unit 124, operating according to the new contact procedure 1600, stores the received contact information, including the normalized voice telephone numbers, in the contacts data file 322 and updates the phone index tables 326 (i.e., to enable rapid retrieval and population of the voice telephone numbers control 438) and appropriate system index tables 318. In accordance with step 1624 of procedure 1600, the central processing unit 124 updates the contacts name control 426 and the voice telephone numbers control 438 of the user interface 306 to display the new contact's name and associated voice telephone numbers. Then, as directed by step 1628 of procedure 1600, the central processing unit 124 removes the new contact dialog box 1628 from application window 402 and from the display device 172 before ceasing execution according to procedure 1600 at step 1632.

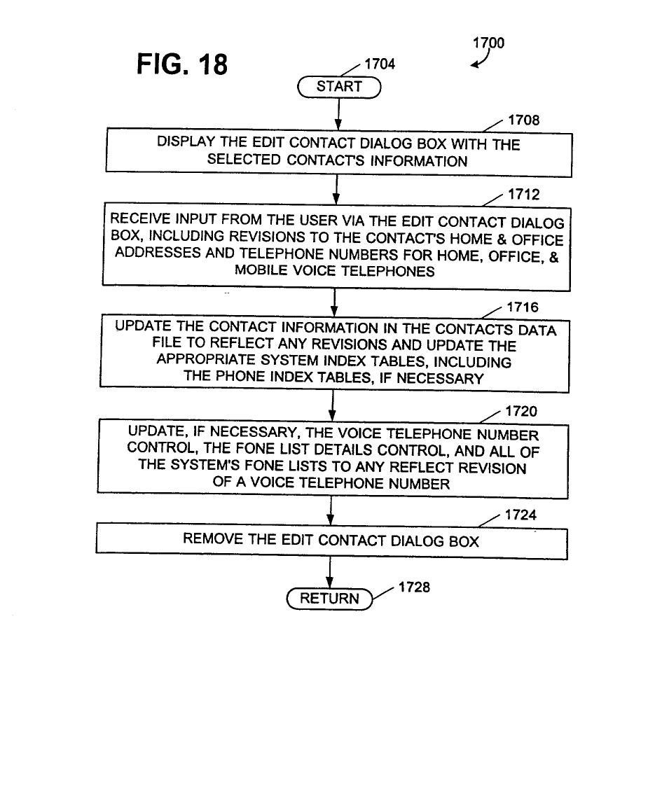

FIG. 18 illustrates an edit contact procedure 1700, in accordance with the preferred embodiment of the present invention, which the central processing unit 124 follows when a user selects “Edit Contact” from a pull-down menu associated with the Edit option of the menu bar 406. After starting operation in accordance with the procedure 1700 at step 1704, the central processing unit 124 causes the retrieval of the contact data associated with a currently selected contact (i.e., selected by the user from the contacts name control 426) and display of an edit contact dialog box, including the retrieved contact data, in application window 402 on display device 172. Note that the edit contact dialog box, although not shown herein, is substantially similar to the new contact dialog box 530 with the exception that the edit contact dialog box does not enable input and/or modification of the contact's name. Proceeding according to procedure 1700 at step 1712, the central processing unit 124 receives potential inputs from the user, including revisions to the contact's addresses (i.e., office and home) and to the contact's voice telephone numbers. Then, following step 1716, the central processing unit 124 creates, if necessary, revised “normalized” voice telephone numbers and updates the contacts data file 322 with the revised “normalized” voice telephone numbers and any other revisions that were made by the user to the contact's data. The central processing unit 124 also updates the phone index tables 326 and the system's other data files and tables 318, if necessary. Continuing according to step 1720 of procedure 1700, the central processing unit 124 updates, with all revised voice telephone numbers, the voice telephone numbers control 438, the fone list details control 442, and all of the system's named fone lists 350 to reflect all revisions of voice telephone numbers included therein. Next, following step 1724, the central processing unit 124 removes the edit contact dialog box from the application window 402 and, according to step 1728, continues execution according to the user interface process 1100.

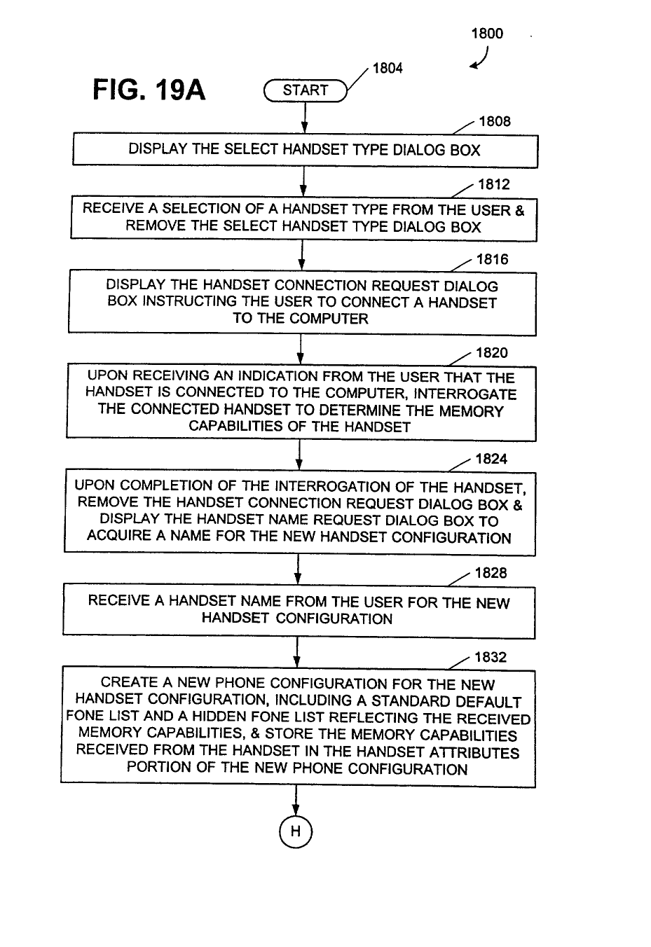

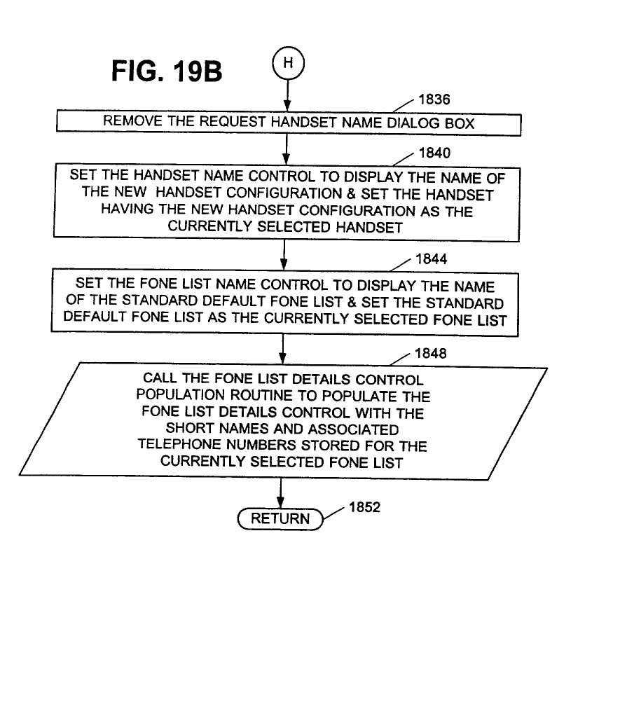

FIG. 19 depicts a new handset configuration procedure 1800 of the preferred embodiment of the present invention which is followed by the central processing unit 124, upon selection of button control 414b from button bar 410 by a user, to create a new handset configuration 342 within the application 116. Upon initiation of the procedure 1800 at step 1804, the central processing unit 124 displays, according to step 1808, the select handset type dialog box 610 in application window 402 on display device 172. According to step 1812 of procedure 1800 and upon the selections of a handset type and Next button control 618 by the user, the central processing unit 124 receives the selected handset type and removes the select handset type dialog box 610 from the application window 402. Proceeding in accordance with procedure 1800 at step 1816, the central processing unit 124 displays the handset connection request dialog box 630 in application window 402. Upon receiving a selection of the Next button control 634 from the user to indicate that the handset 104 is appropriately connected to the computer system 112, the central processing unit 124, acting in accord with procedure step 1820, interrogates the connected handset 104 to collect data representing the handset's memory capabilities (i.e., by sending the handset 104 a command which instructs the handset 104 to transmit data representing its memory capabilities).

Then, following procedure step 1824 when the interrogation process is complete, the central processing unit 124 removes the handset name request dialog box 620 from the application window 402 and displays, in the application window 402, the handset name request dialog box 646 to acquire a name for the new handset configuration 342 from the user. Acting in accordance with procedure steps 1828 and 1832, the central processing unit 124 receives a name for the new handset configuration 342 and, upon receipt of the selection of the Next control button 654 by the user, creates a new handset configuration 342 in the phone configuration data file 330. Creation of the new handset configuration 342 includes the creation of an empty standard, default named fone list 350 and an empty hidden fone list 366 which are sized in terms of the maximum number of entries, the maximum number of characters includeable in a short name, and the maximum number of characters includeable in a voice telephone number according to the data collected from the handset 104 at step 1820. Creation of the new handset configuration 342 further includes the storage of the collected memory capability data in the portion of the phone configuration 342 including handset attribute data 346.

Proceeding in accordance with procedure step 1836, the central processing unit 124 removes the request handset name dialog box 646 from the application window 402 and display device 172. Then, the central processing unit 124, following procedure step 1840, sets the handset name control 430 to display the name of the new handset configuration 342 and sets the new handset configuration 342 to be the currently selected handset. The central processing unit 124, continuing according to step 1844, sets the standard, default named fone list 350 for the new handset configuration 342 to be the currently selected fone list 350 and sets the fone list name control 434 to display the name of the standard, default named fone list 350. Next, following procedure step 1848, the central processing unit 124 operates temporarily in accordance with the populate fone list details control procedure 1500 to populate the fone list details control 442 with rows 474 having only row number indicators 482 (i.e., since the standard, default named fone list 350 is empty at this time). Upon completion of the population of the fone list details control 442, the central processing unit 124 resumes execution, as directed by procedure step 1852, in accordance with the user interface process 1100.

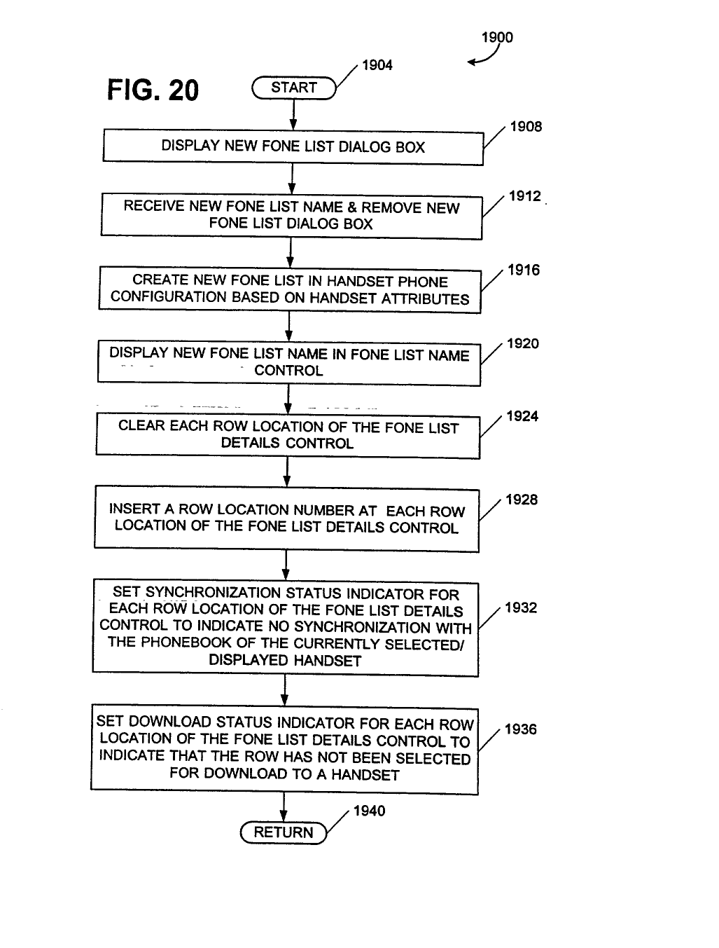

FIG. 20 displays, in accordance with the preferred embodiment of the present invention, a new fone list procedure 1900 which the central processing unit 124 follows upon the selection of the new fone list button control 414c by the user. After starting execution in accordance with the procedure 1900 at step 1904, the central processing unit 124, functioning according to procedure step 1908, displays the new fone list dialog box 682 in the application window 402 on display device 172. Proceeding with procedure step 1912, the central processing unit 124 receives a new fone list name from the user via the new fone list name control 686 and removes the new fone list dialog box 682 from the application window 402. The central processing unit 124, according to procedure step 1916, creates a new named fone list 350 in the phone configuration 342 of the currently selected handset based upon the memory attribute data 346 present in the phone configuration 342 (i.e., thereby creating a new named fone list 350 having a maximum number of entries, a maximum number of characters for short names, and a maximum number of characters for voice telephone numbers which matches the limitations of the currently selected handset's phone book memory 244).

Then, according to procedure steps 1920 and 1924, the central processing unit 124 displays the name of the new named fone list 350 in the fone list name control 434 and clears each row 474 of the fone list details control 442. In accordance with procedure step 1928, the central processing unit 124 then inserts a row number indicator 482 in each row 474 of the fone list details control 442 (i.e., the maximum value inserted for a row number indicator 482 is the maximum number of entries stored in the memory attribute data 346 of the phone configuration 342 for the currently selected handset. Advancing to operate according to procedure step 1932, the central processing unit 124 sets the synchronization status indicator 486 for each row 474 of the fone list details control 442 to indicate that none of the rows 474 includes a fone list entry 470 which matches that of a row 256 of the phone book memory 244 of the currently selected handset. The central processing unit 124, following procedure step 1936, then sets the download status indicator 490 of each row 474 of the fone list details control 442 to indicate that none of the rows 474 includes a fone list entry 470 which has been selected for download to a wireless handset 104. Upon setting of the download status indicators 490 and as directed at procedure step 1940, the central processing unit 124 resumes execution according to the user interface process 1100.

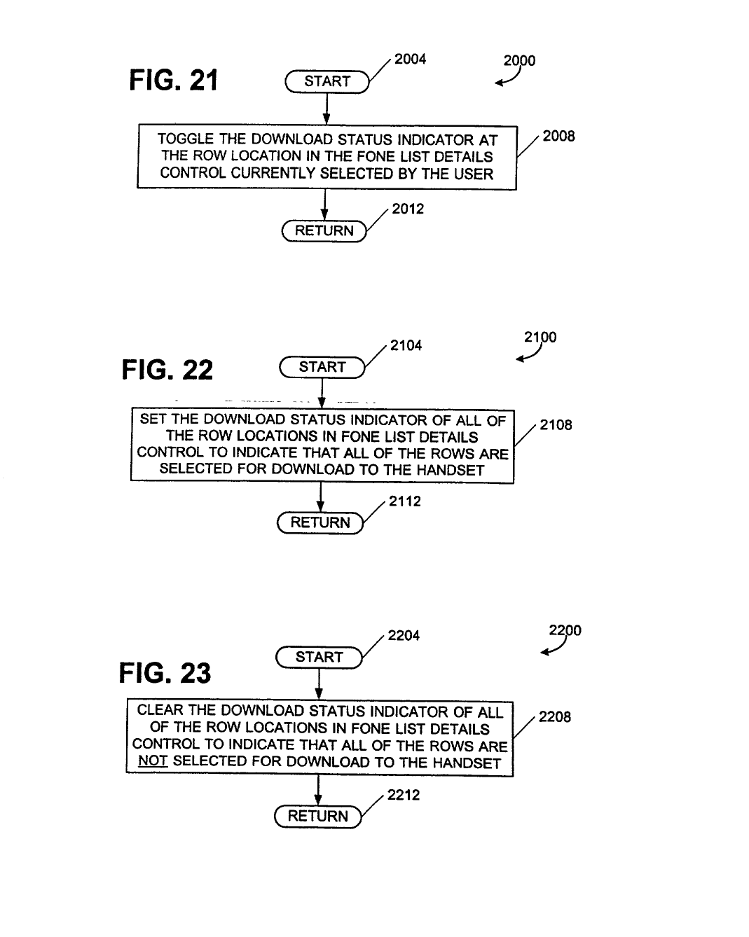

FIG. 21 depicts a toggle download status procedure 2000 in accordance with the preferred embodiment of the present invention. After starting according to step 2004, the central processing unit 124 toggles the download status indicator 490 (i.e., from “set” to “clear” or from “clear” to “set”) associated with the row location 474 (i.e., and the fone list entry 470 at that row location 474) in the fone list details control 442 which is currently selected by the user. Upon completion of the toggle operation, the central processing unit 124, according to procedure step 2012, resumes execution according to the user interface process 1100.

FIG. 22 illustrates a tag all procedure 2100 in accordance with the preferred embodiment of the present invention. After starting according to step 2104, the central processing unit 124 sets the download status indicator 490 of all of the row locations 474 (and, hence, of all the fone list entries 470) of the fone list details control 442. Upon completion of the tagging, or setting, operation, the central processing unit 124, in accordance with procedure step 2112, resumes execution according to the user interface process 1100.

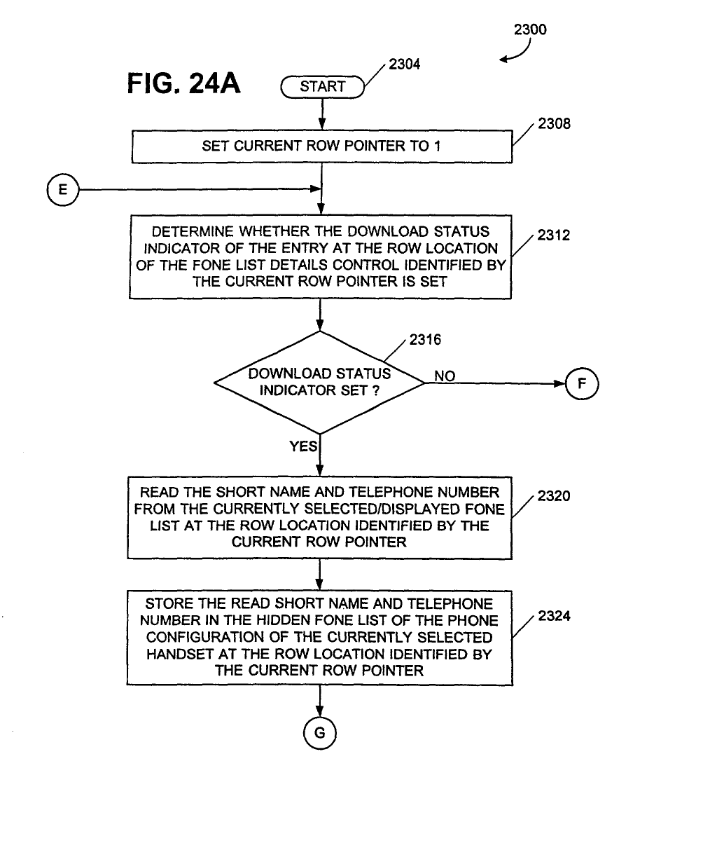

FIG. 23 displays a tag all procedure 2200 in accordance with the preferred embodiment of the present invention. After starting according to step 2204, the central processing unit 124 clears the download status indicator 490 of all of the row locations 474 (and, hence, of all the fone list entries 470) of the fone list details control 442. Upon completion of the untagging, or clearing, operation, the central processing unit 124, in accordance with procedure step 2212, resumes execution according to the user interface process 1100.

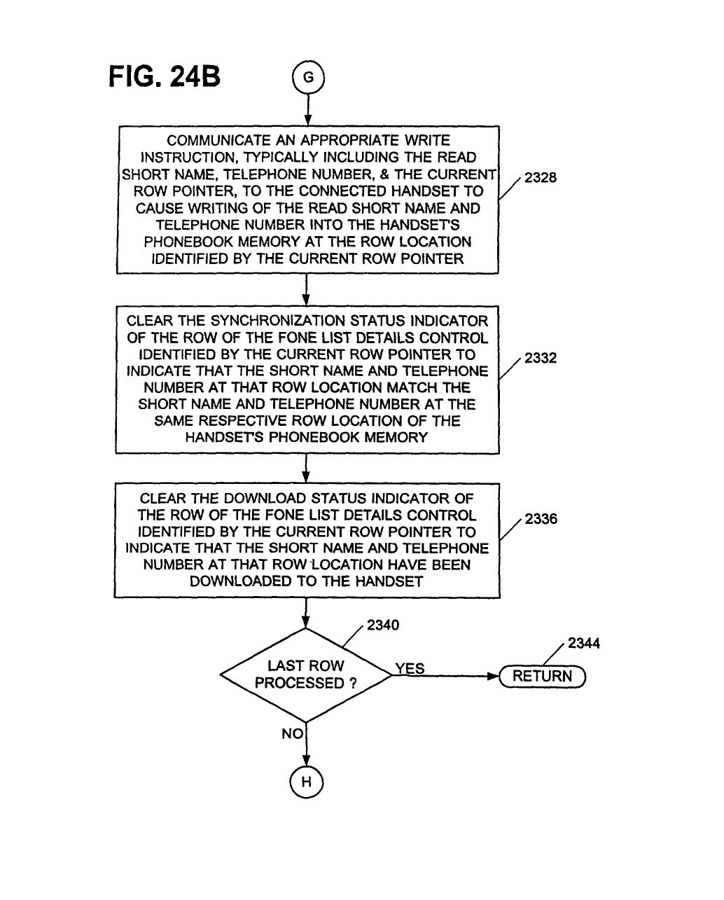

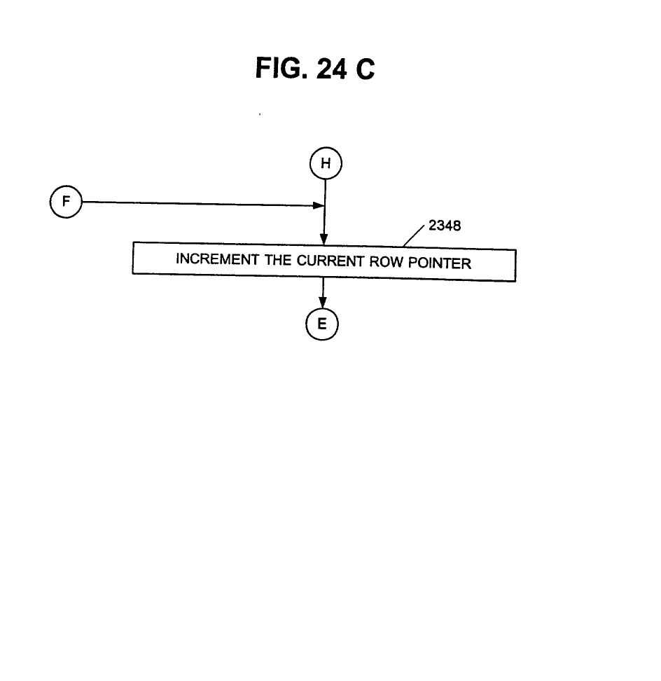

FIG. 24 depicts a download procedure 2300 in accordance with the preferred embodiment of the present invention. After starting at step 2304, the central processing unit 124 sets a current row pointer to 1 at step 2308 and proceeds to step 2312, where the central processing unit 124 determines whether the download status indicator 490 of the fone list entry 470 at the row location 474 of the fone list details control 442 identified by the current row pointer is set. If the central processing unit 124 decides, at step 2316, that the download status indicator 490 is not set, then the fone list entry 470 is not downloaded to a connected wireless handset 104 and the central processing unit 124 increments the current row pointer at step 2348 before returning to step 2312. If the central processing unit 124 decides, at step 2316, that the download status indicator 490 is set, then the central processing unit 124 reads, at step 2320, the short name 494 and voice telephone number 498 of the currently selected row (i.e., that row pointed to by the current row pointer) from the named fone list 350 displayed in the fone list details control 442. Continuing at step 2324, the central processing unit 124 stores the read short name 494 and voice telephone number 498 in the hidden fone list 366 of the phone configuration 342 of the currently selected handset at the row location pointed to by the current row pointer.

Next, at step 2328, the central processing unit 124 communicates an appropriate write instruction, typically including the read short name 494, voice telephone number 498, and the current row pointer to the connected handset 104 to cause the handset's central processing unit 240 to write the read short name 494 and voice telephone number 498 into the handset phone book memory 244 at the current row pointer. Proceeding to step 2332, the central processing unit 124 clears the synchronization status indicator 486 of the row of the fone list details control 442 identified by the current row pointer to indicated that the short name 494 and voice telephone number 498 at that row location 474 match the short name and voice telephone number at the same respective row location of the handset phone book memory 244. Then, at step 2336, the central processing unit 124 clears the download status indicator 490 of the row 474 of the fone list details control 442 identified by the current row pointer to indicate that the short name 494 and voice telephone number 498 of the fone list entry 474 have been downloaded to the handset 104.

Continuing at step 2340, the central processing unit 124 determines whether the last row has been processed by comparing the current row pointer (i.e., which doubles a current count of the number of rows processed) to the maximum number of rows 474 of the named fone list 350 (i.e., as stored in the memory attribute data 346 of the phone configuration 342 for the currently selected handset). If the current row pointer and the maximum number of rows are equal, the last row 474 has been processed and the central processing unit 124 resumes execution of the user interface process 1100 as directed by procedure step 2344. If the current row pointer is less than the maximum number of rows, the last row 474 has not been processed and the central processing unit 124 increments the current row pointer at step 2348 before looping back to step 2312.

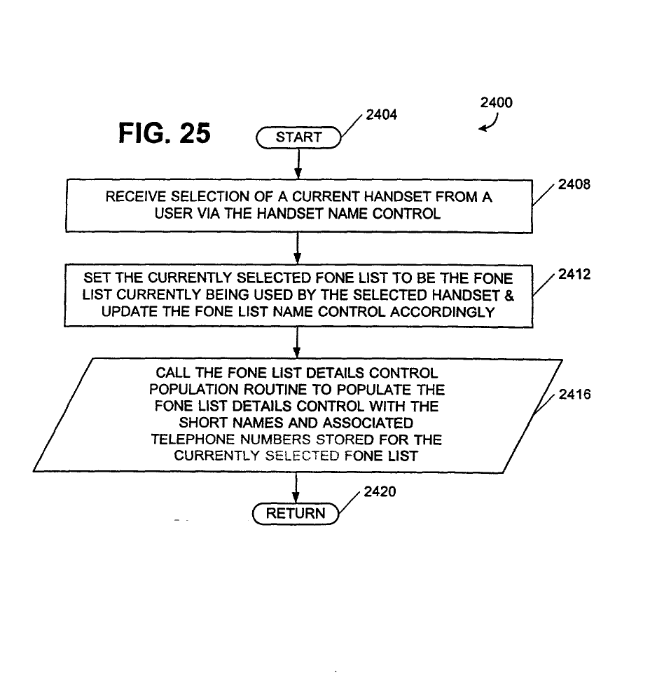

FIG. 25 illustrates a select handset procedure 2400 in accordance with the preferred embodiment of the present invention. After starting at step 2404, the central processing unit 124 receives, at step 2408, a selection of a current handset from a user via the handset name control 430 making the selected handset the “currently selected handset”. Then, at step 2412, the central processing unit 124 sets the currently selected named fone list 350 to be the named fone list 350 currently being used by the selected handset and updates the fone list name control 434 accordingly. Next, at step 2416, the central processing unit 124 operates according to the populate fone list details control procedure 1500 to populate the fone list details control 442 with the short names and associated voice telephone numbers stored for the currently selected named fone list 350. At step 2420, the central processing unit 124 resumes execution according to the user interface process 1100.

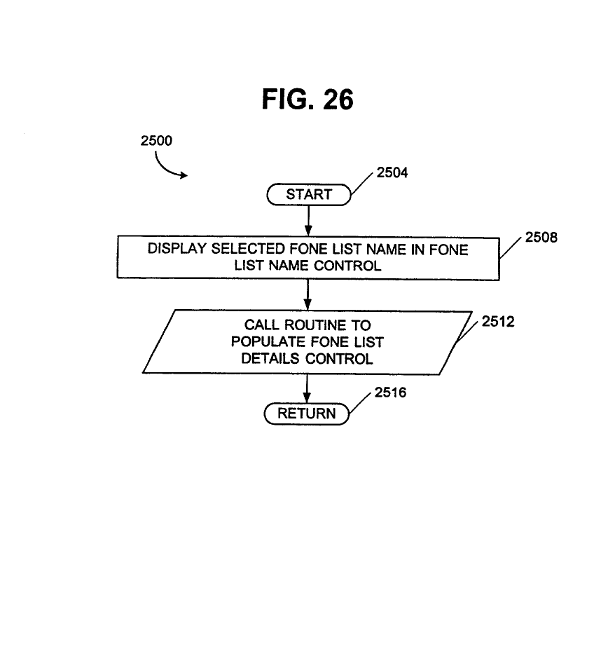

FIG. 26 displays a select fone list procedure 2500 in accordance with the preferred embodiment of the present invention. After starting at step 2504, the central processing unit 124 receives a selection of a named fone list 350 via the fone list name control 434 and displays the name of the selected named fone list 350 control 434. Then, at step 2512, the central processing unit 124 functions according to the steps of the populate fone list details control procedure 1500 to populate the fone list details control 442 with fone list entries 470 from the selected named fone list 350. At step 2516, the central processing unit 124 resumes execution according to the user interface process 1100.

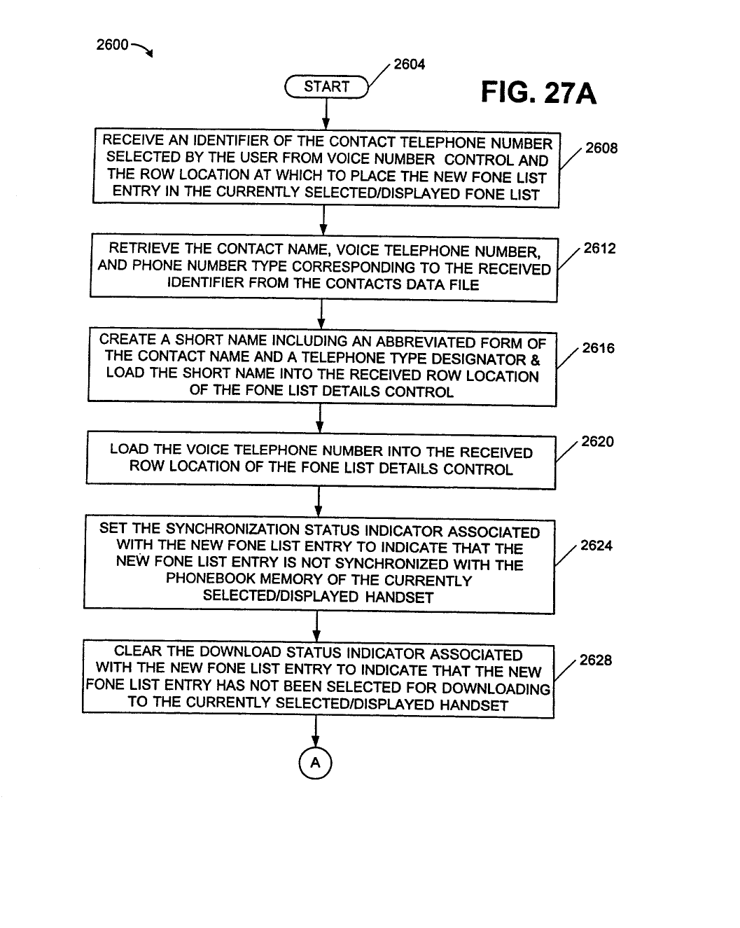

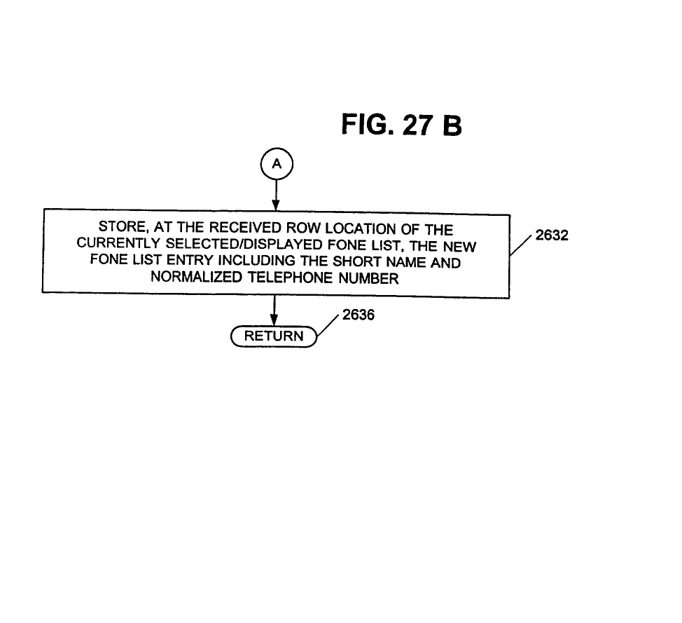

FIG. 27 depicts an add fone list entry procedure 2600 in accordance with the preferred embodiment of the present invention. After starting at step 2604, the central processing unit 124 receives an identifier of the contact voice telephone number 466 selected by the user from the voice telephone numbers control 438 and the row location 474 at which to place the new fone list entry in the currently selected/displayed named fone list 350 of the fone list details control 442. Advancing to step 2612, the central processing unit 124 retrieves the contact name 458, voice telephone number 466, and telephone type indicator 462 corresponding to the received identifier from the contacts data file 322. At step 2616, the central processing unit 124 creates a short name 494, including an abbreviated form of the contact name 458 and a telephone type designator, and loads the short name 494 into the received row location 474 of the fone list details control 442. Note that while creating the short name 494, the procedure 2600 utilizes the memory attributes data 346 to shorten the contact's name 458, if necessary, to fit within the appropriate column of the handset's phone book memory 244. Also, the procedure 2600 utilizes the sort order selected by the user to build the short name 494 in the desired last name first or first name first order.

Continuing at step 2620, the central processing unit 124 loads the voice telephone number 498 into the received row location 474 of the fone list details control 442. Then, at step 2624, the central processing unit 124 sets the synchronization status indicator 486 associated with the new fone list entry 470 to indicate that the new fone list entry 470 is not synchronized with the phone book memory 244 of the currently selected handset. Proceeding at step 2628, the central processing unit 124 clears the download status indicator 490 associated with the new fone list entry 470 to indicate that the new fone list entry 470 has not been selected for downloading to the currently selected/displayed handset. Next, at step 2632, the central processing unit 124 stores, at the received row location 474 of the currently selected/displayed named fone list 350, the new fone list entry 470 including the short name 494 and the normalized telephone number 498. At step 2636, the central processing unit 124 resumes execution according to the user interface process 1100.

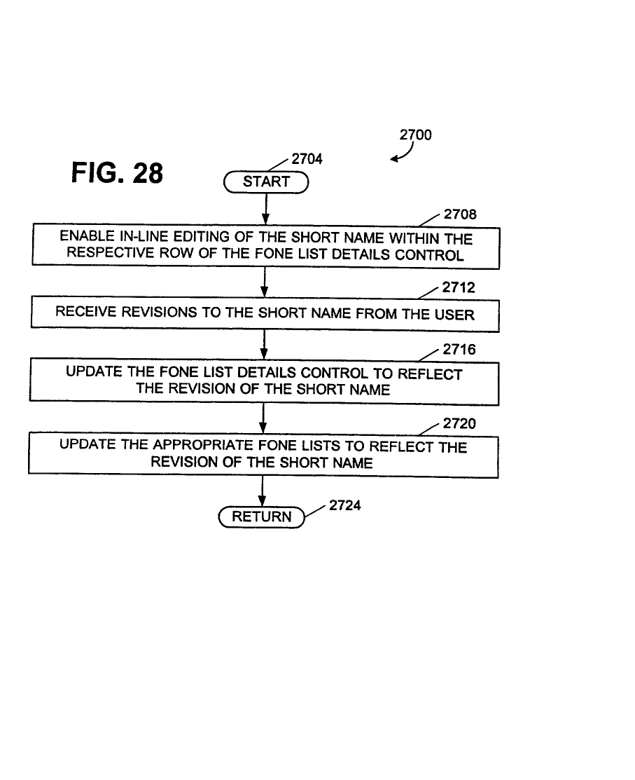

FIG. 28 illustrates an edit short name procedure 2700 in accordance with the preferred embodiment of the present invention. After starting at step 2704, the central processing unit 124, at step 2708, enables in-line editing of the short name 494 within the row 474 of the fone list details control 442 selected by the user. At step 2712, the central processing unit 124 receives revisions to the short name 494 from the user. Continuing at step 2716, the central processing unit 124 updates the fone list details control 442 to reflect revision of the short name 494. Next, at step 2720, the central processing unit 124 updates the appropriate named fone lists 350 (i.e., all of the named fone lists 350 which contain the revised short name 494) to reflect, or incorporate, the revision of the short name 494 in the currently selected/displayed named fone list 350. Then, at step 2724, the central processing unit 124 resumes execution according to the user interface process 1100.

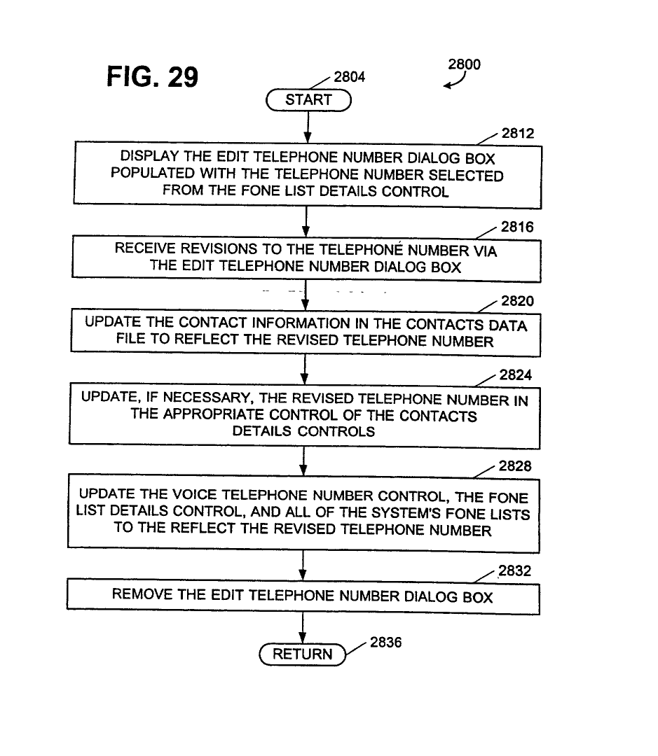

FIG. 29 displays an edit telephone number procedure in accordance with the preferred embodiment of the present invention. After starting at step 2804, the central processing unit 124 displays, at step 2812, an edit telephone number dialog box populated with the voice telephone number 498 selected from the fone list details control 442. Then, at step 2816, the central processing unit 124 receives revisions to the voice telephone number 498 via the edit telephone number dialog box. Continuing at step 2820, the central processing unit 124 updates the contact information in the contacts data file 322 to reflect the revised telephone number. At step 2824, the central processing unit 124 updates, if necessary, the revised telephone number in the appropriate controls 428a, is 428b, 428c of the contact details tab controls 428. Next, at step 2828, the central processing unit 124 updates the voice telephone numbers control 438, the fone list details control 442, and all of the system's named fone lists 350 to reflect, or incorporate, the revised voice telephone number 498. Proceeding to step 2832, the central processing unit 124 removes the edit telephone number dialog box from the application window 402. Then, at step 2836, the central processing unit 124 resumes execution according to the user interface process 1100.

What has been described above is the preferred embodiment of the present invention. It is, of course, not possible to describe every conceivable combination of apparatuses or methodologies for purposes of describing the present invention. However, one of ordinary skill in the art will recognize that many further combinations, permutations, and modifications of the present invention are possible. Therefore, all such possible combinations, permutations, and modifications are to be included within the scope of the claimed invention, as defined by the claims below.

We claim:

1. A method of managing the contents of a wireless telephone memory, the method comprising the steps of:
collecting a plurality of telephone numbers associated with a respective plurality of contacts;
selecting only certain voice telephone numbers from the collected plurality of telephone numbers;
grouping the selected voice telephone numbers into a group; and,
downloading the group of selected voice telephone numbers to a wireless telephone.
